(19) United States
(12) Patent Application Publication
(10) Pub. No.: US 2026/0359326 A1
(43) Pub. Date: Nov. 12, 2026

(54) OPEN RESOURCE DISCOVERY OF KEY-ACTIVATED ACTIONS FOR ACCESSING ENTERPRISE DATA

(71) Applicant: Business Mobile AG, Kreuzlingen (CH)

(72) Inventors: Thomas Failer, Kreuzlingen (CH); Maximilian Ralph Peter von und zu Liechtenstein, Douglas (IM)

(73) Assignee: Business Mobile AG, Kreuzlingen (CH)

(21) Appl. No.: 19/738,724

(22) Filed: Jul. 13, 2026

Related U.S. Application Data
(63) Continuation-in-part of application No. 17/133,887, filed on Dec. 24, 2020, now Pat. No. 12,705,259.
(63) Continuation of application No. 19/722,848, filed on Jun. 27, 2026.

(51) Int. Cl. G06F 16/28

(52) U.S. Cl. CPC G06F 16/288

(57) ABSTRACT

A system, method, and non-transitory computer-readable medium are described for generating discoverable machine-callable data actions from enterprise view metadata. An enterprise view metadata parser retrieves metadata comprising a primary view field catalog and a related-resource key field set. The primary view may comprise an archive view, production view, replicated view, or customer-defined custom view on a standard business object. The related resource may comprise a related view, replication object, change-log stream, event stream, or message-bus topic. An activation field group resolver compares the field catalog with the related-resource key field set and generates an activation field group identifying fields sufficient to query, retrieve, subscribe to, or consume the related resource. An action-schema generator generates a machine-callable data action definition having required input parameters derived from the activation field group. A publication interface publishes the action definition in an action catalog or discovery document. An execution gateway validates invocations against the activation field group before execution or consumption.

### CROSS-REFERENCE TO RELATED APPLICATIONS

This application is a continuation-in-part of U.S. patent application Ser. No. 17/133,887, filed Dec. 24, 2020, entitled “Technique for Generating Views of Archived Business Data,” and a continuation of U.S. patent application Ser. No. 19/722,848, filed Jun. 27, 2026, the disclosures and contents of which are incorporated herein by reference in their entireties.

### BACKGROUND OF THE INVENTIONS

### 1. Field of the Inventions

The document relates to systems, devices, methods, and related computer program products for viewing archive data. More particularly, this patent specification relates to auto-generating views and their user interfaces, wherein such views are useful in accessing archived business data stored on relational databases.

In additional embodiments, the present disclosure relates to systems, devices, methods, and related computer program products for generating machine-discoverable and machine-callable historical-data actions from archived business-object metadata. More particularly, certain embodiments relate to a historical action activation compiler 700 that determines activation field groups 744 from archive view metadata, field catalogs, relationship metadata, and business-object metadata, and that generates corresponding machine-callable action definitions 750.

In further embodiments, the machine-callable action definitions 750 may be published in a machine-readable discovery document 724 and invoked by a consuming enterprise system through an action execution gateway 718. In still further embodiments, an action invocation may be validated against one or more activation field groups 744 before a query is executed against a tenant archive store 704.

### 2. Description of the Related Art

Any discussion of the related art throughout the specification should in no way be considered as an admission that such related art is widely known or forms part of common general knowledge in the field. Unless otherwise indicated herein, the materials described in this section are not prior art to the claims in this application and are not admitted to be prior art by inclusion in this section.

The present inventions relate to the generation of views for viewing archived business data. Several methods for generating views are known that allow a user to view business data which is held in an archive database. Amongst these is the individual approach, which comprises the individual definition of archive objects. The individual approach requires the writing of individual export programs and the authoring of individual views. Another approach known to the prior art is the classical archiving approach. The classical approach involves archiving a data model which may have originally conformed to an industry-standard data. Because of the fact that possible customization of the production data model is ignored with the classical approach, standard data archiving programs can be used and, later on, standard views may be used to access the archived business data through a user interface.

### SUMMARY OF THE INVENTIONS

The known view generators for archived business data suffer from either losing custom data in exchange for being able to re-use standard views, or conversely from high cost of implementation because of the need to manually engineer custom export programs and custom views with custom user interfaces, i.e. a cumbersome and highly laborious process.

The present inventor, however, has recognized that a middle ground is possible in that a standard object model can be used to define relationships between different types of tables and that on field level, auto-generated export programs and view-generating programs can take into account highly customized table fields and automatically transpose them onto the standard data model. Hence no data gets lost while making the transfer to the archive.

In accordance with a specific embodiment of the inventions, when data is stored on a production database, such as the database of an SAP ERP system for example, it is first transferred to an archive database, and in a second step a view is generated that allows a user to search and access the data on the archive database. In particular embodiments of the inventions both the archiving and the archive retrieval processes are enabled by common business objects. Such business objects may be realized through a standard data model. An example of such a standard data model would be a “sales order” business object, whereby the business object comprises the database tables for the sales orders header tables and the sales order line item tables. The difference between a standard business object and a customized business object is that a standard business object is normally defined by a vendor of an ERP (enterprise resource planning) system, such as SAP ERP for example. It is a task left for customers to adapt standard tables that are associated with a business object to their own requirements. Typically, custom fields can be added to standard tables and custom tables can also be defined, which then can be linked to standard tables through foreign key relationships. In accordance with an illustrative feature of the present inventions, a view, which is a search and display type user interface for a particular business object, may be generated by first making a user select a standard business object from a catalog of business objects. Once a business object is selected then the system may lookup which database tables are associated with the business object. In an advantageous feature of the present inventions, the system may next connect to the production database and parse each table that is associated with the standard business object. An output of the parsing process may be metadata relating to the table schema associated with the business object. In particular, one such output may be a field catalog of all fields in a table, including any custom fields which have been added by the customer to the standard data model. One more output may be custom tables, which may be linked to the standard tables of the business object by foreign key relationships. In the next step a view may be defined. In a preferred embodiment a view is implemented on a webserver as a user interface made up of a series of web pages which have been implemented with HTML5 and Javascript technology. Those skilled in the art will realize that a view can be implemented with any technology capable of producing a user interface, including Windows apps or Android apps. An advantageous aspect of the instant inventions is that a view may be generated either automatically, or with minimal user interaction, whilst at the same time not omitting any data that is part of the customized data model on the production database. In order to realize that goal, a view generator, which is implemented according to principles of the present inventions, may let a user select any table fields which are comprised in the production-derived metadata for either search or display fields. Once the desired makeup of a view is finalized by the user, then an auto-generation feature may be started, wherein said auto-generation may generate the SQL queries necessary to query the archive database and wherein said auto-generation may also generate the user interface artefacts necessary to search and display the archive data relating to a business object.

In additional embodiments, archive view metadata and activation field groups are not used only to generate human-readable archive views or hyperlinks to sub-views. Instead, one or more activation field groups 744 may be used to generate machine-callable action definitions 750 for accessing historized enterprise data. Each machine-callable action definition 750 may identify a historical-data action, one or more required input parameters, an output schema, and an archive view or sub-view to be queried when the historical-data action is invoked.

In accordance with certain embodiments, a historical action activation compiler 700 may access archive view metadata, field catalogs, relationship metadata, and business-object metadata associated with a tenant archive store 704. The historical action activation compiler 700 may determine that a set of fields in a primary archive view or in a business context is sufficient to activate a related archive view, sub-view, historical lookup, or other historical-data action. The set of fields may be stored or represented as an activation field group 744.

In accordance with further embodiments, an action-schema generator 714 may generate a machine-callable action definition 750 from the activation field group 744. The machine-callable action definition 750 may include a required input parameter schema derived from the activation field group 744 and an output schema derived from an archive view, sub-view, or business-object view. A discovery-document generator 716 may publish the machine-callable action definition 750 in a machine-readable discovery document 724 so that a consuming enterprise system 720 can automatically discover historical-data actions that are available from an information management platform 702.

In accordance with still further embodiments, an action execution gateway 718 may receive an invocation of a machine-callable action definition 750 from a consuming enterprise system 720. Before executing a query against the tenant archive store 704, the action execution gateway 718 may validate that the invocation contains values corresponding to the activation field group 744 for the invoked historical-data action. If the invocation does not contain the required values, the action execution gateway 718 may reject the invocation or return a remediation instruction.

In some embodiments, the machine-readable discovery document 724 is or comprises an Open Resource Discovery document. In other embodiments, the machine-readable discovery document 724 may comprise another machine-readable resource discovery document, service description, API description, action catalog, tool manifest, data-product description, event description, or combination thereof. Accordingly, the use of Open Resource Discovery is illustrative and not limiting.

In one aspect, the present inventions may include a computer-implemented system for generating discoverable machine-callable data actions, the system comprising: an enterprise data store storing enterprise data; an enterprise view metadata parser configured to retrieve view metadata associated with the enterprise data store, the view metadata comprising at least a custom-view field catalog of a customer-defined custom view on a standard business object and a related-resource key field set of a related enterprise resource; an activation field group resolver configured to compare the custom-view field catalog with the related-resource key field set and to generate an activation field group identifying one or more fields sufficient to query, retrieve, subscribe to, or consume data from the related enterprise resource; an action-schema generator configured to generate, from the activation field group, a machine-callable data action definition comprising an action identifier and a required input parameter schema derived from the activation field group; a publication interface configured to store or publish the machine-callable data action definition in at least one of an action catalog or a machine-readable discovery document; and an action execution gateway configured to receive an action invocation request identifying the machine-callable data action definition and to issue a validated query, retrieval request, subscription request, or consumption request for the related enterprise resource only after validating that the action invocation request includes values corresponding to the required input parameter schema. Another feature of this aspect of the present inventions may be that the related enterprise resource comprises at least one of a replication object, a change-log stream, a message-bus topic, an event stream, a production view, an operational view, an archive view, or a related customer-defined custom view. Another feature of this aspect of the present inventions may be that the customer-defined custom view comprises at least one of a subset of fields of the standard business object, a renamed field, a calculated field, a joined field, a custom field, or a field from a custom table. Another feature of this aspect of the present inventions may be that the related enterprise resource comprises a replication object configured to represent data exposed through the customer-defined custom view. Another feature of this aspect of the present inventions may be that the related enterprise resource comprises a change-log stream recording create, update, delete, insert, modify, or destroy operations associated with the standard business object, the customer-defined custom view, or a replication object. Another feature of this aspect of the present inventions may be that the machine-callable data action definition defines at least one of a query action, retrieval action, subscription action, event-consumption action, export action, or change-log-consumption action. Another feature of this aspect of the present inventions may be that the machine-callable data action definition further comprises at least one of an output schema, a query template, a subscription template, an event-consumption template, an action access rule, an action policy rule, or an action version identifier. Another feature of this aspect of the present inventions may be that the machine-readable discovery document comprises an Open Resource Discovery document comprising an API resource entry corresponding to the machine-callable data action definition. Another feature of this aspect of the present inventions may be that the system may further include an action matching service configured to compare a context field set of a consuming enterprise system with the required input parameter schema and to generate a matched data action list. Another feature of this aspect of the present inventions may be that the system may further comprise a metadata change detector configured to detect changed view metadata and to cause regeneration of at least one of the activation field group, the machine-callable data action definition, the action catalog, or the machine-readable discovery document.

In another aspect, the present inventions may include computer-implemented method for generating discoverable machine-callable data actions, the method comprising: retrieving, by an enterprise view metadata parser, view metadata associated with an enterprise data store, the view metadata comprising a primary view field catalog of a primary enterprise data view and a related-resource key field set of a related enterprise resource; comparing, by an activation field group resolver, the primary view field catalog with the related-resource key field set; generating, by the activation field group resolver, an activation field group identifying one or more fields sufficient to query, retrieve, subscribe to, or consume data from the related enterprise resource; generating, by an action-schema generator, a machine-callable data action definition comprising an action identifier and a required input parameter schema derived from the activation field group; storing or publishing, by a publication interface, the machine-callable data action definition in at least one of an action catalog or a machine-readable discovery document; receiving, by an action execution gateway, an action invocation request identifying the machine-callable data action definition; and issuing a validated query, retrieval request, subscription request, or consumption request for the related enterprise resource only after validating that the action invocation request includes values corresponding to the required input parameter schema. Another feature of this aspect of the present inventions may be that the primary enterprise data view comprises a customer-defined custom view on a standard business object. Another feature of this aspect of the present inventions may be that the related enterprise resource comprises a replication object generated based on a customer-defined custom view. Another feature of this aspect of the present inventions may be that the related enterprise resource comprises a change-log stream or message-bus topic associated with create, update, delete, insert, modify, or destroy operations. Another feature of this aspect of the present inventions may be that storing or publishing the machine-callable data action definition comprises generating an Open Resource Discovery document comprising an API resource entry corresponding to the machine-callable data action definition. Another feature of this aspect of the present inventions may be that the method may further comprise comparing a context field set of a consuming enterprise system with the required input parameter schema and generating a matched data action list comprising one or more machine-callable data actions invocable from the context field set. Another feature of this aspect of the present inventions may be that the method may further comprise rejecting the action invocation request when at least one of the following occurs: the action invocation request omits a value required by the activation field group; the action invocation request fails validation against an access rule; the action invocation request fails validation against a retention rule; the action invocation request fails validation against a lifecycle rule; or the action invocation request fails validation against a policy rule governing query, retrieval, subscription, event consumption, or message-bus consumption.

In another aspect, the present inventions may include a non-transitory computer-readable storage medium storing instructions which, when executed by one or more processors, cause the one or more processors to perform operations comprising: retrieving view metadata associated with an enterprise data store, the view metadata comprising a primary view field catalog of a primary enterprise data view and a related-resource key field set of a related enterprise resource; generating an activation field group by comparing the primary view field catalog with the related-resource key field set, the activation field group identifying one or more fields sufficient to query, retrieve, subscribe to, or consume data from the related enterprise resource; generating a machine-callable data action definition comprising an action identifier and a required input parameter schema derived from the activation field group; storing or publishing the machine-callable data action definition in at least one of an action catalog or a machine-readable discovery document; and causing an action execution gateway to issue a validated query, retrieval request, subscription request, or consumption request for the related enterprise resource only after validating that an action invocation request includes values corresponding to the required input parameter schema. Another feature of this aspect of the present inventions may be that the enterprise data store comprises a tenant archive store, wherein the enterprise data comprises historized enterprise data, and wherein the primary enterprise data view comprises an archive view generated from metadata comprising custom fields, custom tables, or foreign-key relationships. Another feature of this aspect of the present inventions may be that the operations further comprise supplying the machine-callable data action definition to an artificial-intelligence planner as part of a generated tool manifest, receiving a proposed agent action from the artificial-intelligence planner, and rejecting the proposed agent action when the proposed agent action does not include values corresponding to the activation field group.

Other features, aspects and advantages of the present inventions will become apparent from the following discussion and detailed description.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIG. 1 depicts a type of archive view generating procedure known in the prior art.

FIG. 2 depicts another type of archive view generating procedure known in the prior art.

FIG. 3 depicts an archive view generating procedure making use of standard business objects in connection with parsed custom table metadata, embodying the principles of the present invention.

FIG. 4 is block diagram depicting the sequence of operations for generating an archive view, according to an example embodiment.

FIG. 5 is system diagram depicting the components which ae utilized in the archive view generating procedure, according to an example embodiment.

FIG. 6 is symbolic user interface of an archive view depicting the auto-generation of links to sub-views with foreign key relationships to the primary view, according to an example embodiment.

FIG. 7 depicts a system architecture for generating discoverable historical-data actions from archive view metadata, according to an additional example embodiment. FIG. 7 includes a historical action activation compiler 700, an information management platform 702, a tenant archive store 704, an archive metadata parser 706, a standard business object repository 708, an archive view metadata store 710, an activation field group resolver 712, an action-schema generator 714, a discovery-document generator 716, an action execution gateway 718, a consuming enterprise system 720, an open resource discovery endpoint 722, a machine-readable discovery document 724, and a generated action catalog 726.

FIG. 8 depicts the determination of activation field groups from archive view metadata, according to an additional example embodiment. FIG. 8 includes a primary archive view 730, a primary view field catalog 732, a related archive view 734, a related view key field set 736, relationship metadata 738, custom field metadata 740, custom table metadata 742, an activation field group 744, a field-group-to-view binding 746, and a field-group-to-parameter mapping 748.

FIG. 9 depicts generation of machine-callable action definitions from activation field groups, according to an additional example embodiment. FIG. 9 includes a machine-callable action definition 750, an action identifier 752, a required input parameter schema 754, an output schema 756, an archive query template 758, an action-to-archive-view mapping 760, an action access rule 762, an action retention rule 764, and an action version identifier 766.

FIG. 10 depicts publication of generated action definitions through a resource discovery document, according to an additional example embodiment. FIG. 10 includes an open resource discovery publication adapter 770, an Open Resource Discovery document 772, an Open Resource Discovery package 774, an Open Resource Discovery entity type entry 776, an Open Resource Discovery API resource entry 778, an Open Resource Discovery data product entry 780, an Open Resource Discovery access strategy 782, an OpenAPI document link 784, a discovery document hash 786, and a discovery document version 788.

FIG. 11 depicts consumer-side discovery and context matching, according to an additional example embodiment. FIG. 11 includes an SAP system 790, an SAP business screen 792, a screen-context field set 794, an action matching service 796, a matched historical-data action list 798, and a selected historical-data action 800.

FIG. 12 depicts runtime validation and execution of a generated historical-data action, according to an additional example embodiment. FIG. 12 includes an action invocation request 810, an activation validation engine 812, an authorization validation engine 814, a retention validation engine 816, a rejected invocation response 818, an archive query dispatcher 820, a generated archive query 822, a historical data result set 824, and an invocation audit log 826.

FIG. 13 depicts an optional artificial-intelligence consumer of generated action definitions, according to an additional example embodiment. FIG. 13 includes an artificial-intelligence planner 830, a generated tool manifest 832, a generated prompt context 834, a proposed agent action 836, a validated agent action 838, and a rejected agent action 840.

FIG. 14 depicts metadata-change detection and regeneration of generated action definitions and resource discovery documents, according to an additional example embodiment.

FIG. 14 includes a metadata change detector 850, changed archive view metadata 852, a regenerated activation field group 854, a deprecated action marker 856, a regenerated action catalog 858, a regenerated Open Resource Discovery document 860, and a revalidation job 862.

FIG. 15 depicts generation of discoverable machine-callable data actions from customer-defined custom views, replication objects, and change-log resources, according to an additional example embodiment. FIG. 15 includes a standard business object 870, a customer-defined custom view 872, a replication object 874, a change-log stream 876, a message bus 878, an enterprise view metadata parser 880, an enterprise action activation compiler 882, an activation field group resolver 884, an activation field group 886, an action-schema generator 888, a machine-callable data action definition 890, a discovery publication adapter 892, a machine-readable discovery document 894, an action execution and subscription gateway 896, a consuming enterprise system 898, a context field set 900, a validated query or subscription request 902, a retrieved data or consumed event set 904, a policy validation engine 906, a custom-view field catalog 908, and a replication/change-log key field set 910.

While the inventions will be described in connection with the preferred embodiments, it will be understood that the scope of protection is not intended to limit the inventions to those embodiments. On the contrary, the scope of protection is intended to cover all alternatives, modifications, and equivalents as may be included within the spirit and scope of the inventions as defined by the appended claims.

### DETAILED DESCRIPTION OF THE INVENTION

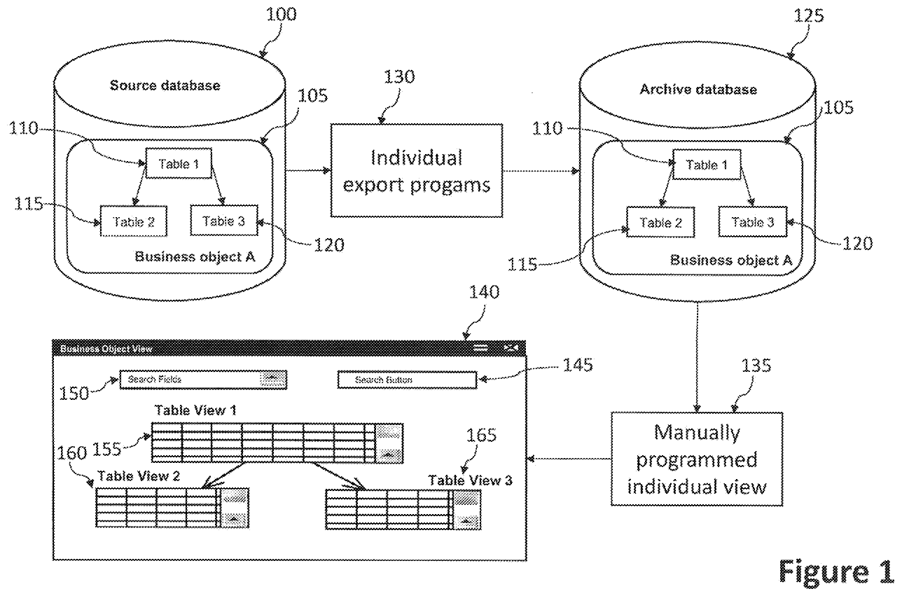

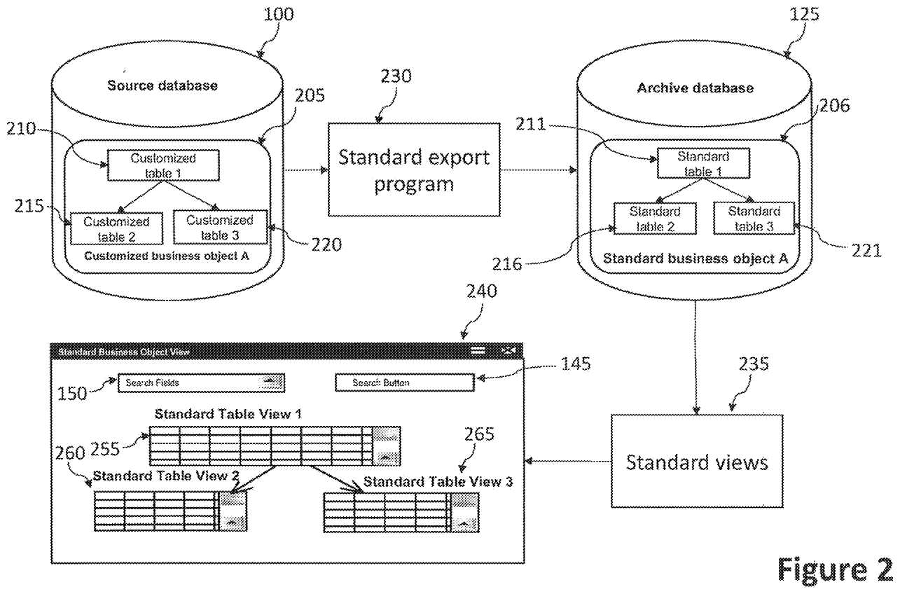

Among the archive view generation techniques known to the prior art are those shown in FIGS. 1 and 2.

FIG. 1 depicts an individual approach to archive view generation. An individual approach involves a custom archive solution for each production database. A production database 100 may be any relational database containing business data. This may be a multi-model database management system such as an Oracle database, or an in-memory, column-oriented, relational database management system such as SAP HANA for example. A production database may also be a logical database, in the sense that there is a logical layer implemented on top of the database layer. In SAP ERP, one of the leading enterprise resource planning systems, there are three kinds of logical tables, which are simulated in a database-vendor independent layer on top of the vendor-dependent core database. In SAP there are Transparent Tables which exist with the same row and column structure as in the underlying physical database, but there may be differences in the technical data types; there are also Pooled Tables where the data of a plurality of these pooled tables is stored in a common table in the physical database; and there are also Cluster Tables which store key value pairs, wherein the keys are the same in the physical database, but the values comprise data, possibly including row or table data, which is compressed and/or encrypted before being stored in the underlying physical database. An archive database 125 may be any data store capable of long-term storage of table data which has been transferred from a production database. Hence in the context of this specification the term archive database is not limited to a database filled with aged business data for the purpose of data retirement. As an example, the novel techniques presented hereinafter may also be useful in a data migration context, where all data from a source system is transferred, as opposed to only aged data. An archive database may be implemented with various technical architectures, whereby the possible architectures comprise those of the production database. An archive database may also be implemented with file-based approaches, such as SAP's ADK approach, wherein a production database is archived with table records being written into files and where an index table is maintained that allows efficient searching for the relevant records in the relevant archive files. It is common practice to define business objects 105 in order to group tables which are related to a header table. An example of a business object would be a sales order. There will preferably be a leading table of sales orders, which is referred to as the header table. Any sales order may have line items, for which there is a one-to-many relationship. Consequently, the line items would normally be stored in a separate table with a foreign key relationship to the header table. Also, a sales order may store price finding data and textual data in yet more related tables. Hence a header row, i.e. a row in the header table, may link to many other tables and there may be different kinds of relationships between those table. Therefore a business object may be made up of a header row in a header table and potentially many rows in many related tables, whereby the related rows may be related in a business context to the header row. Table 1 110 is an example of such a header table. Related tables Table 2 115 and Table 3 120 are related to Table 1 in a business context and they may be linked through foreign key relationships. It is important to note that in the “individual” approach to archiving, which is described in FIG. 1, there are the same business objects with the same underlying tables both in the source database 100 and in the archive database 125. Essentially the business objects in the archive database 125 are exact copies of the business objects in the source database 100. It is important to note that they are copies in a business sense, not necessarily on a technical level. So, whilst the archive database contains the same business data, that data may be stored in a different file format or database format. The data types may also be different. Hence when business data is moved from a source database running Oracle to an archive database running MSSQL, it is to be expected that the technical data types may be slightly different, but crucially when that business data is retrieved through a viewer, then the viewer will see the same business data as would have been visible on the source system. In the “individual” approach it is necessary to write individual export programs 130 in order to transfer the data from the source database 100 to the archive database 125. This is one major disadvantage of the “individual” approach, because rather than being able to purchase on “off the shelf” type industry-standard archiving solution, an operator of a source database 100 has to employ very considerable efforts and associated costs in order to retire business data to an archive database. It often defeats the objective of saving costs in any case. For what is the benefit of retiring data to an archive database, when the overall costs of the “individual” approach to archiving are in fact greater than leaving the aged data in the production database in the first instance. Another factor is the need to program a series of views for the archived data. Archiving data only serves its objective if the aged data is not only safely retired to the archive database, but if there is also a user interface to search and retrieve the aged data. Whilst the aged data is still in the production system, the tools, reports and application programs of the production system can be used to access the aged data. However, on an archive database, no such array of tools is available. Hence a custom user interface has to be laboriously programmed in order to view and retrieve the archived data, should the need ever arise. Programming such user interfaces for searching and retrieving archived data is a task that generally is even more laborious and costly than writing the export programs to transfer the aged data. Hence the “individual” approach comprises programming a manually programmed individual view 135 in order to be able to view business object A 105, once it resides in the archive database 125. A business object view 140 may comprise one or more search fields 150 and a command interface for executing a search, commonly a button 145. A business object view 140 may also comprise a result screen, which in turn comprises Table View 1 155, which is visual rendition of a table of results which may be based on the primary keys of the header table 110. It is important to note that Table View 1 155 does not need to exhibit the same schema as Table 1 110. It is possible to flatten a business object without losing data. An example would be a sales order, where on the database there are separate tables for sales orders and for sales order line items. A view of such data could combine both tables into a single table view, which contains the full set of information of the underlying tables in one single view table, where each row contains a line item plus the corresponding header data. However, commonly the table views tend to closely correspond to the underlying database tables. Hence in the example embodiment Table View 1 155 corresponds to Table 1 110, and conversely Table View 2 160 corresponds to Table 2 115, whilst Table View 3 165 corresponds to Table 3 120.

FIG. 2 depicts another prior art approach to creating archive views. It is often termed the “classical” approach, because unlike the extremely costly “individual” approach, it enjoys widespread industry support due to fact that it is relatively quick and easy to implement. This ease of use is owed to the fact that it allows vendors of archiving solution to offer one-fits-all types of “off-the-shelf” archiving and view generating solutions. Hence even if the source database 100 may be heavily customized to an individual firm's requirements, with custom tables and custom fields, the archive database only offers an industry-standard data model and the archive views are also standard views built around the standard data model. Sometimes vendors of such solutions offer the customers to enhance the standard views and the standard data models in order to better reflect the actual production data, but such a process of manually enhancing standard business models and standard views can be very laborious. In fact, such a task can be similar in scope and in cost, that it compares to the “individual” approach. Hence often a customer is put before the choice of either using a standard data model bought “off-the-shelf” and accepting inevitable data loss, or implementing an “individual” approach by either writing the archive solution from the ground up or by spending an almost similar effort in enhancing an industry-standard solution. This is exemplified in FIG. 2 whereby a customized business object A 205 on the source database 100 is transposed into standard business object A 206 on the archive database 125. Likewise, customized table 1 210, the header table, corresponds to standard table 1 211, whilst customized table 2 215, corresponds to standard table 2 216 and customized table 3 220, corresponds to standard table 3 221. Because of the fact that the customized tables 210, 215 and 220 were originally based on standard tables 211, 216 and 221 it is possible to use a standard export program 230 in order to move aged data from the source database to the archive database. However, the standard export program 230 will only be able to transport those fields and tables which are comprised in the standard data model. Any field or tables that have been added by the customer after originally adopting the standard data model will necessarily be lost. One of the main advantages of the “classical” approach is that standard views 235 provide a ready-made user interface for accessing archive data. Item 240 is an example of a standard business object view. In contrast to the “individual” approach wherein the result lists comprised custom fields and custom tables, in the “classical” approach only industry-standard table views are shown to the user, such as Standard Table View 1 255, Standard Table View 2 260 and Standard Table View 3 265 in the depicted example embodiment.

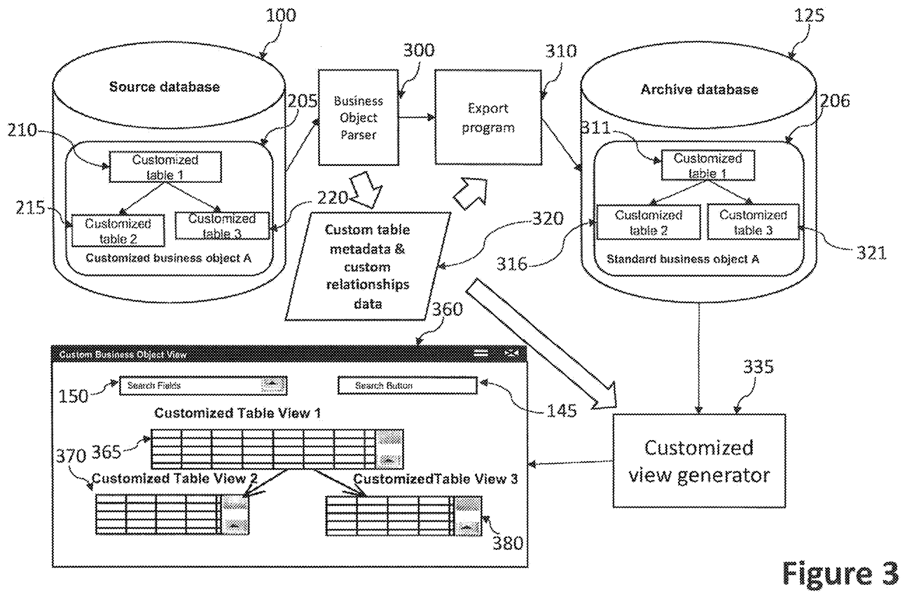

FIG. 3 depicts a view generating technique embodying the principles of the present inventions that is more cost-efficient than the prior art approaches whilst at the same time ensuring that custom data in custom tables or custom fields of standard tables is not lost during the process. A system which embodies the present inventions may hence comprise a Business Object Parser 300. A Business Object Parser is a program which has access to definitions of standard business objects and which then accesses a production database and automatically or semi-automatically determines divergences from the standard data model. An embodiment of the present inventions has implemented a Business Object Parser as a JAVA program which connects to a production database, via the JDBC driver, whereby the production database is an Oracle Database v19c. JDBC drivers are client-side adapters (installed on the client machine, not on the server) that convert requests from Java programs to a protocol that the DBMS can understand. The JDBC driver has been used to extract metadata from the data sources corresponding to the production system. Metadata generally includes the name, size and number of rows of each table present in a database, along with the columns in each table, their data types, precisions, etc. To get metadata from the data source using a JDBC driver, the getMetaData( ) method is called, using the Connection object. Those skilled in the art will realize that many other ways of connecting to a database and extracting metadata are possible. There are many drivers other than the JDBC drivers and most of these offer methods for extracting metadata. An example embodiment extracts metadata in a series of steps: First, a business object definition is loaded from a repository of standard business objects. A business object definition may comprise a list of tables, an indication of which of these tables constitutes the header table and an indication of how the tables in the list are related to each other; Second, for each table comprised in a business object definition the metadata of the corresponding tables on the productive database is queried; Third, for each table comprised in a business object definition find related tables which are linked through a foreign key relationship. The third step is optional in the sense that steps one and two are still useful in their own right and that the third step brings added value.

The second step may be carried out on an Oracle production database, for example, with the following SQL statement:

```
select t.table_name,
    , t.column_name
    , t.data_type
  from user_tab_columns t
    left join user_cons_columns cc
      on (cc.table_name = t.table_name and
        cc.column_name = t.column_name)
where t.table_name= ‘BO_TABLE_NAME’);
```

The third step may be carried out on an Oracle production database, for example, with the following SQL statement:

select * from all_constraints where r_constraint_name in (select constraint_
name from all_constraints where table_name=‘BO_TABLE_NAME’);

The term BO_TABLE_NAME is a placeholder that stands for a table within the business object definition. The third step thus executes an SQL statement which yields all linked tables for a table in a business object definition. Similar SQL queries exist for different DBMS and those skilled in the art will realize that the third step may be carried out with any other alternative SQL statement that is capable of returning as an output all tables which are linked to an input table. Optionally the third step may also use a filter, which can identify which of the linked tables is a custom table that has been defined as a business object related table by the customer. Such a filter may make use of naming conventions which indicate a customer table. For example, in SAP systems customer tables which are added to an SAP-standard business model are routinely prefixed with either a Z or a Y. Another possible filter criterion is the table creator, as revealed from the table metadata. The table creator may indicate if a certain table has been created when the standard data model was initially installed, or afterwards by a different user. The output of the Business Object Parser 300 is custom table metadata along with custom data relationships 320. In a preferred embodiment the Business Object Parser 300 writes the custom table metadata & custom relationships data to an XML file in the file system.

The system for generating archive views, pursuant to principles of the inventions, may also comprise an export program 310. The purpose of the export program 310 is to extract the aged business data from the source database 100 and to transform it into a form that can be imported into the archive database 125. In a preferred embodiment the generated export program may be a JAVA program which outputs comma-separated files (CSVs), wherein CSV is a data format which can be used to import data into most common databases. Those skilled in the art will realize that there are many equally suitable alternatives for exporting data in a format that can be imported by an archive database. In a preferred embodiment the export program 310 is auto-generated by using the Apache Velocity framework. Velocity is a Java-based template engine. It permits using a simple template language to reference objects defined in Java code. It can be used to generate SQL, PostScript and XML from templates. It can be used either as a standalone utility for generating source code and reports, or as an integrated component of other systems. There are other template engines, which are equally useful for auto-generating the export program 310. It is not even necessary to use a template engine; the code for the export program 310 may also be written as a manual effort in any programming language. In accordance with an advantageous feature of the present inventions the generated export program 310 may be enabled for reading and outputting custom fields in standard tables and custom tables linked to standard tables. Due to the export program 310 being capable of outputting also the custom fields of a customized business object, the standard business object A, comprises not a set of standard tables, as in the prior art, but the same customized tables as in the source database 100. Hence, in the depicted example embodiment customized source tables 210, 215 & 220 translate to customized target tables 311, 316 & 321. Except for the technical data types, the business data contained in the target tables fully matches that of the source tables. The customized view generator 335 is a component in an exemplary embodiment which is tasked with generating a search, list and display type user interface for a selected business object. In one embodiment the view generator 335 has been implemented as a JAVA program which takes as input both the custom table metadata & custom relationship data 320 and the corresponding object model of a standard business object 206. In an alternative embodiment instead of reading previous output from the Business Object Parser 300, as stored during or after creation of the business object in the archive database 125, it is also possible to invoke the business object parser 300 as part of the operation of the customized view generator 335. So, the customized view generator 335 may either read previously stored custom table metadata & custom relationships data 320, or it may explicitly cause the generation of such data by directly invoking the business object parser 300. The output of the customized view generator 335 may be a customized business object view 360 which is a user interface for search, list and display of an archived business object. It is important to note that in contrast to a standard business object view 240 (see FIG. 2) a customized business object view 360 comprises a representation of the tables that make up a business object, as they appear on the source database 100, i.e. the customized business object view may contain both the customer-specific fields that are not in the standard data model as well as non-standard customer tables added to the standard data model. Hence view 360 may comprise a customized table view 1 365 which relates to the business object header table 210, i.e. an originally standard table which has been enhanced with customer-specific fields. Likewise, customized table views 370 and 380 relate to customer-enhanced tables 215 and 220 respectively.

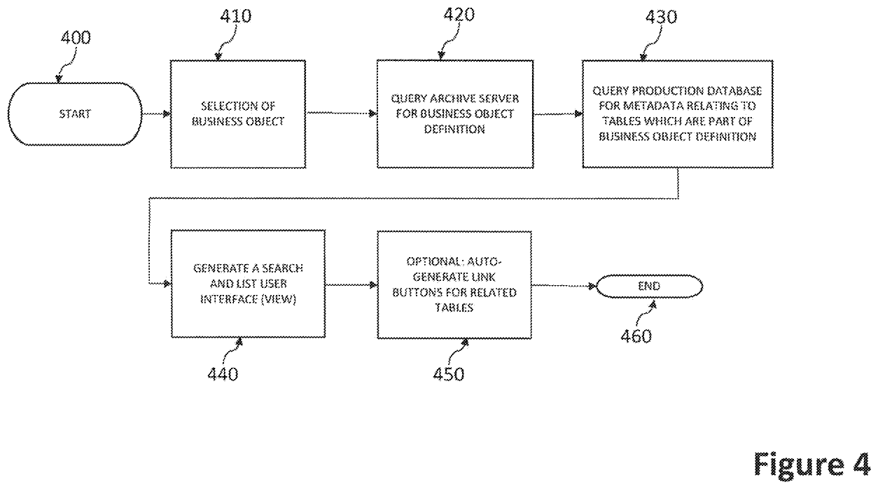

FIG. 4 relates to a flow diagram that illustrates the sequence of steps when a view is generated, according to an example embodiment. At the start 400 one or more business objects are selected 410. In one example embodiment a business object may be selected by being presented with a selectable list of business objects whereby the selectable list is part of a user interface that has been realized as a JAVA program and whereby the selectable list has been pre-installed with the JAVA program. Alternative ways of selecting a business object are also possible. The next step 420 may be the querying an archive server for a business object definition. A business object definition may also be stored on a server different to the archive server or on the same computer which is hosting the user interface. The next step 430 involves retrieving metadata relating to tables which are part of the business object definition. Such metadata is associated with an output of the business object parser 300. Step 440 involves generating a search, list and display type user interface for the selected business objects. As an optional step 450 auto-generated link buttons may be inserted into the user interface. Such link buttons relate to sub-views in the same view. Sub-views which are linked are based on tables which exhibit primary keys which are comprised in the field catalog of the primary view. So, when a view is generated, the primary key fields of all tables of the business object may be automatically compared against the field catalog of the view. If the primary keys of such a table are found in said field catalog, then a link to a sub-view may be inserted in the user interface, whereby the sub-view relates to said table. The flow in FIG. 4 is ended with 460.

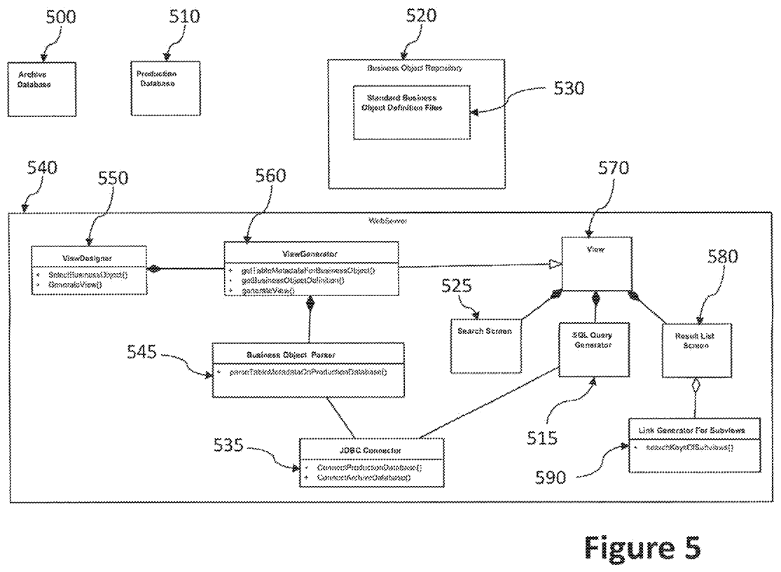

FIG. 5 is a UML-compliant system diagram of an example embodiment which is implementing the view generator on a web server 540. The generated views 570 have access to an archive database 500 that comprises retired business data from a production database 510. A business object repository 520 may be used to serve standard business object definition files 530. An embodiment of the present inventions may serve the business object definitions as XML files, whereby a business object definition may comprise definitions relating to which tables make up a business object; which of these tables is the header table; and information indicating how the tables are related to each other. In alternative embodiments business object definitions may be stored in other suitable formats or in other suitable storage locations. A view 570 may comprise a search screen 525, an SQL query generator 515 and a result list screen 580. The result list screen 580 may further comprise a link generator for sub-views 590, which in the example embodiment has a method “searchKeysOfSubviews( )” for taking each field in the field catalog of the primary view and for searching through the primary keys of the tables forming part of the business object in order to find a match. A view generator 560 may be associated with a view designer 550, wherein the view designer in the depicted example comprises methods “SelectBusinessObject( )” for selecting a business object on which a view is to be generated and method “GenerateView( )” for starting off the view-generating process of which view 570 is an output. The view generator 560 comprises method “getTableMetadataForBusinessObject” for retrieving table metadata from the production database 510 for the tables that are associated with a given business object; as well as method “getBusinessObjectDefinition( )” for retrieving the definition of a business object from the business object repository 520; as well as method “generateView( )”, which serves as the command for starting off the view generation process. The view generator 560 is associated with the business object parser 545, which in turn may comprise a method “parseTableMetadataOnProductionDatabase( )”, which may connect to the production database 510 in order to parse the tables which makeup a business object definition. The connection to either the archive database 500 or the production database 510 may be effected by the JDBC connector 535 with methods “ConnectProductionDatabase( )” and “ConnectArchiveDatabase( )” respectively.

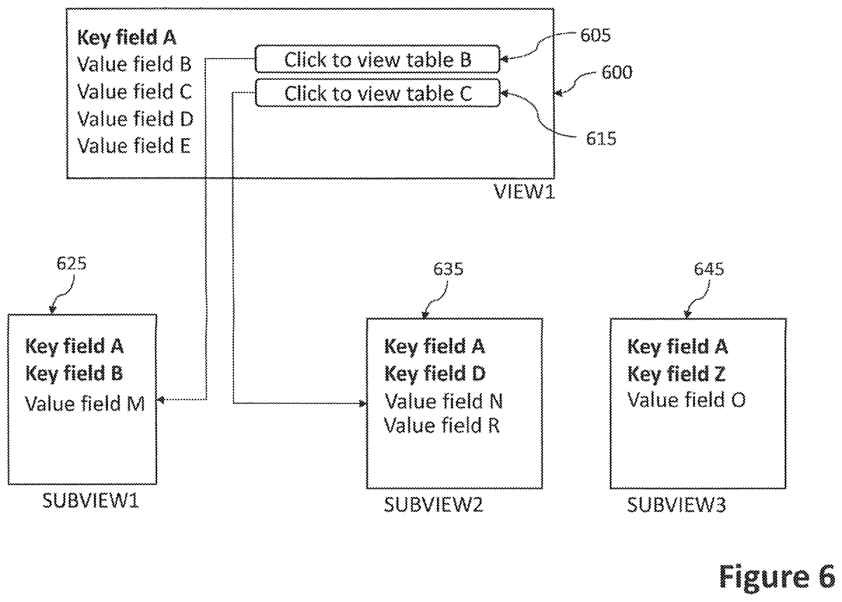

FIG. 6 provides further detail regarding the linking to sub-views as referenced in 590 in FIGS. 5 and 450 in FIG. 4. View 1 600 relates to a result list that is displayed after a successful search for a business object. The view relates to a table that has a primary key comprising afield A. Alongside the key values the view also displays a number of value fields, namely B, C, D and E in the depicted example. There also exist three sub-views, namely sub-view 1 625, sub-view 2 635 and sub-view 3 645. Subview 1 625 has primary key fields A and B. Due to fields A and B also being part of the field catalog of view 1 600, a link 605 may be displayed alongside field B in view 1 600. There is a similar situation with sub-view 2 635, whereby primary key fields A and D can both be found in the field catalog for view 1 600. Hence a link 615 to sub-view 2 635 is displayed in view 1 600. The link is displayed in vicinity of value field D in view 1 600 in order to better illustrate the circumstance that field D in table A (on which view 1 600 is based) is a foreign key to table C (on which sub-view 2 635 is based). Sub-view 3 645 is not referenced with a link in view 1 600 because key field Z is not a field which is comprised in the field catalog of view 1 600. As an alternative to displaying links such as 605 and 615 whenever the primary keys of a subview match the field catalog of a view, another embodiment uses a configuration data structure, termed activation fields groups hereinafter, which explicitly links a set of fields in the field catalog of a business object with the display of a link to a certain sub-view. An example of such an activation field group, is the following instruction in pseudo code: “If the fields A, D and F occur in any view of the business object 432, then display a link to sub-view 23 and use said fields as keys when querying said sub-view”. Activation field groups may be defined to apply to any view which is connected to a business object, or they may alternatively be restricted to a single view, of which the following pseudo code would be an example: “If the fields A, D and F occur in view 432 of business object 882, then display a link to sub-view 23 and use said fields as keys when querying said sub-view”.

### Additional Embodiments for Generating Discoverable Key-Activated Historical-Data Actions

The embodiments described above with reference to FIGS. 1-6 include, among other things, the generation of archive views and links to sub-views based on field catalogs, key fields, foreign-key relationships, and activation field groups. Additional embodiments will now be described in which such view-linking and activation-field-group techniques are extended beyond a human-readable archive user interface. In the additional embodiments, activation field groups may be used to generate machine-callable action definitions that are discoverable and invocable by external systems.

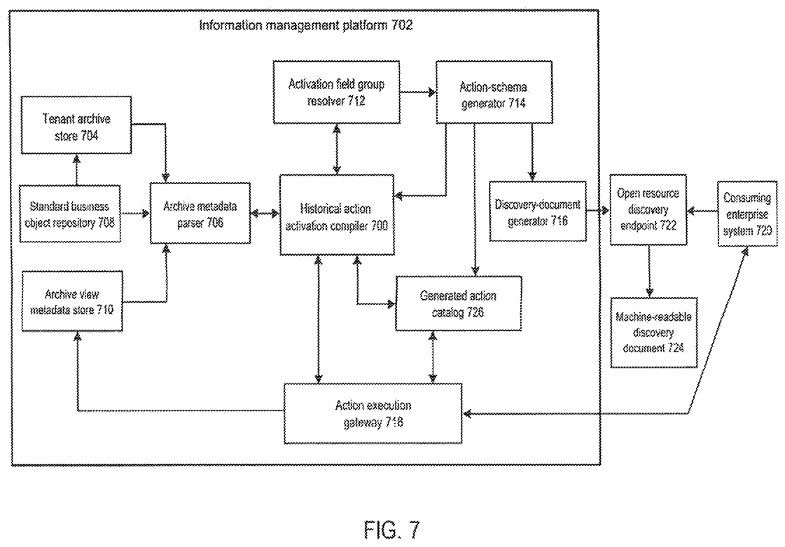

FIG. 7 depicts a system architecture for generating discoverable historical-data actions from archive view metadata, according to an additional example embodiment. An information management platform 702 may comprise or communicate with a tenant archive store 704. The tenant archive store 704 may comprise archived, retired, historized, migrated, transformed, or otherwise preserved enterprise data. In an example embodiment, the tenant archive store 704 comprises archived business data that originated from an SAP system. In other embodiments, the tenant archive store 704 may comprise business data from a non-SAP enterprise system, a plurality of enterprise systems, a data migration environment, a carve-out environment, a merger environment, or a combination thereof.

The information management platform 702 may comprise a historical action activation compiler 700. The historical action activation compiler 700 may be implemented as one or more software modules, services, processes, containers, classes, functions, or other program components executable by one or more processors. In some embodiments, the historical action activation compiler 700 is implemented in the same computing environment as an archive view generator. In other embodiments, the historical action activation compiler 700 is implemented as a separate service that consumes archive view metadata generated by another component of the information management platform 702.

The historical action activation compiler 700 may comprise or communicate with an archive metadata parser 706. The archive metadata parser 706 may retrieve metadata from the tenant archive store 704, from an archive view metadata store 710, from a standard business object repository 708, or from any combination thereof. The metadata retrieved by the archive metadata parser 706 may comprise one or more of: business-object definitions, archive view definitions, sub-view definitions, table names, field names, custom field definitions, custom table definitions, data types, primary-key definitions, foreign-key definitions, relationship definitions, search-field definitions, display-field definitions, access rules, retention rules, or generated query definitions.

The standard business object repository 708 may store definitions of standard business objects. A standard business object definition may comprise definitions of standard tables, standard fields, standard relationships, standard keys, or standard archive views. The archive view metadata store 710 may store tenant-specific archive view metadata. Such tenant-specific archive view metadata may comprise metadata derived from a production system, metadata derived from an archive database, metadata derived from a previously generated archive view, metadata derived from a customer-enhanced business object, or metadata derived from a combination thereof.

The historical action activation compiler 700 may further comprise an activation field group resolver 712. The activation field group resolver 712 may determine one or more field groups that are sufficient to activate, invoke, query, link to, or otherwise access a related archive view, sub-view, historical lookup, or historical-data action. In particular embodiments, the activation field group resolver 712 compares fields present in an archive view or in a business context with key fields of one or more related archive views. If the comparison indicates that a set of available fields is sufficient to query a related archive view, the activation field group resolver 712 may generate an activation field group.

The historical action activation compiler 700 may further comprise an action-schema generator 714. The action-schema generator 714 may generate a machine-callable action definition for a historical-data action corresponding to an activation field group. The machine-callable action definition may comprise an action identifier, required input parameters, an output schema, and a mapping to an archive view, sub-view, query template, or query dispatcher route. In this manner, information that may otherwise be used merely to display a hyperlink in a user interface may be converted into a machine-callable operation that can be discovered and invoked by a consuming enterprise system 720.

The information management platform 702 may further comprise a discovery-document generator 716. The discovery-document generator 716 may generate a machine-readable discovery document 724 that describes one or more machine-callable action definitions generated by the action-schema generator 714. In some embodiments, the machine-readable discovery document 724 is exposed through an open resource discovery endpoint 722. In particular embodiments, the open resource discovery endpoint 722 is implemented as a network endpoint that responds to a discovery request from the consuming enterprise system 720.

The information management platform 702 may further comprise an action execution gateway 718. The action execution gateway 718 may receive an invocation of a machine-callable historical-data action from the consuming enterprise system 720. Before executing a query against the tenant archive store 704, the action execution gateway 718 may validate that the invocation contains values corresponding to a required activation field group for the invoked action. If the invocation is valid, the action execution gateway 718 may dispatch an archive query to the tenant archive store 704. If the invocation is not valid, the action execution gateway 718 may reject the invocation.

A generated action catalog 726 may store machine-callable action definitions generated by the historical action activation compiler 700. The generated action catalog 726 may be used by the discovery-document generator 716 to publish machine-readable action descriptions and by the action execution gateway 718 to validate and execute action invocations. Thus, in certain embodiments, the same generated action catalog 726 provides both a discovery-time description of available historical-data actions and a runtime control structure for determining whether a requested action may be executed.

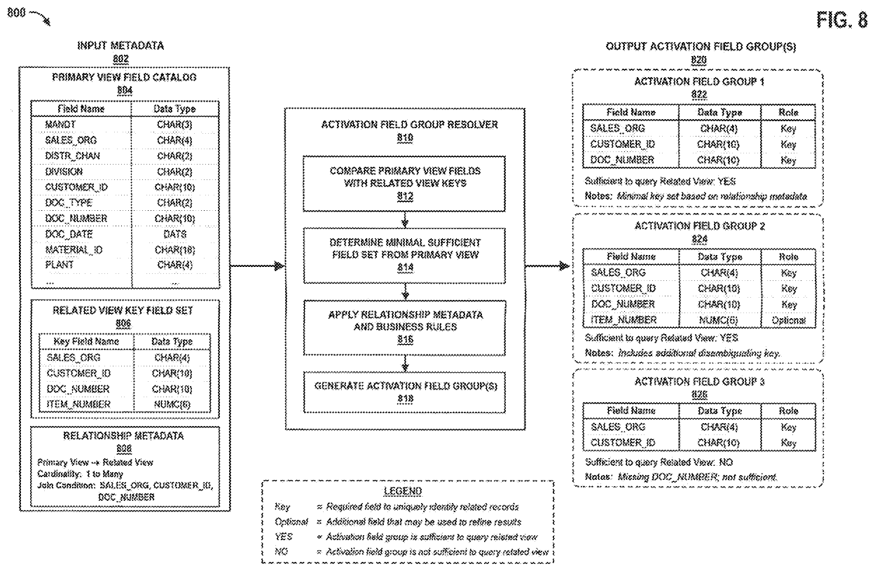

FIG. 8 depicts the determination of activation field groups from archive view metadata, according to an additional example embodiment. A primary archive view 730 may correspond to a generated archive view, a business-object view, a search result view, a list view, a display view, or another view configured to retrieve or display archived business data from the tenant archive store 704. The primary archive view 730 may comprise or be associated with a primary view field catalog 732.

The primary view field catalog 732 may identify fields that are available in the primary archive view 730. Such fields may comprise standard fields, custom fields, technical fields, business key fields, display fields, search fields, foreign-key fields, generated index fields, archive-object fields, or any combination thereof. In some embodiments, the primary view field catalog 732 is generated from metadata previously retrieved by a business object parser. In other embodiments, the primary view field catalog 732 is retrieved from the archive view metadata store 710.

A related archive view 734 may correspond to a sub-view, dependent view, related business-object view, detail view, item view, document view, attachment view, audit view, or other archive view that is accessible from or related to the primary archive view 730. The related archive view 734 may comprise or be associated with a related view key field set 736. The related view key field set 736 may identify one or more fields required to query the related archive view 734.

Relationship metadata 738 may define a relationship between the primary archive view 730 and the related archive view 734. The relationship metadata 738 may comprise one or more of: a primary-key relationship, a foreign-key relationship, a parent-child relationship, a header-item relationship, a business-context relationship, a generated archive-index relationship, a table-join relationship, or a manually configured relationship. In some embodiments, the relationship metadata 738 is derived by comparing metadata of a standard business object with tenant-specific metadata. In further embodiments, the relationship metadata 738 is derived from customized tables or customized fields detected in connection with an archived business object.

Custom field metadata 740 may identify fields that were added to a standard business-object model by a customer or tenant. Custom table metadata 742 may identify tables that were added to a standard business-object model by a customer or tenant. The activation field group resolver 712 may use the custom field metadata 740 and the custom table metadata 742 when determining whether the primary archive view 730 contains sufficient fields to activate the related archive view 734. Accordingly, activation field groups may be generated not only for standard business-object relationships but also for tenant-specific customizations.

The activation field group resolver 712 may compare the primary view field catalog 732 with the related view key field set 736. If all fields of the related view key field set 736 are present in the primary view field catalog 732, or if the relationship metadata 738 provides a mapping from fields in the primary view field catalog 732 to fields in the related view key field set 736, the activation field group resolver 712 may generate an activation field group 744.

The activation field group 744 may comprise a set of field identifiers sufficient to activate the related archive view 734. The activation field group 744 may also comprise data type information, field length information, field conversion information, required/optional parameter information, default value information, tenant identifier information, or authorization information. In some embodiments, the activation field group 744 comprises only fields that are required to query the related archive view 734. In other embodiments, the activation field group 744 comprises required fields and optional fields that may narrow or modify a query against the related archive view 734.

A field-group-to-view binding 746 may associate the activation field group 744 with the related archive view 734. The field-group-to-view binding 746 may identify which archive view, sub-view, query, route, service, or dispatcher target is activated when values for the activation field group 744 are provided. In some embodiments, a single activation field group 744 may activate a plurality of related archive views. In other embodiments, a plurality of activation field groups may activate the same related archive view 734.

A field-group-to-parameter mapping 748 may map fields of the activation field group 744 to input parameters of a machine-callable action definition. The field-group-to-parameter mapping 748 may include parameter names, data types, value conversion rules, formatting rules, canonical field identifiers, source-field identifiers, target-field identifiers, and validation rules. The field-group-to-parameter mapping 748 may be used by the action-schema generator 714 when generating a machine-callable action definition and may be used by the action execution gateway 718 when validating an action invocation.

In an example embodiment, the primary archive view 730 relates to a sales order header and comprises a sales order number field. The related archive view 734 relates to sales order items and the related view key field set 736 comprises the sales order number field and an item number field. If the primary archive view 730 comprises both fields, the activation field group resolver 712 may generate an activation field group 744 comprising the sales order number field and the item number field. If the primary archive view 730 comprises only the sales order number field, the activation field group resolver 712 may generate a different activation field group 744 for a header-level historical-data action but may refrain from generating an item-level historical-data action requiring the item number field.

In another example embodiment, a customer-specific table is represented in the custom table metadata 742 and is related to a standard business-object table through relationship metadata 738. The customer-specific table may require a custom case identifier field represented in the custom field metadata 740. If the primary view field catalog 732 contains the custom case identifier field, the activation field group resolver 712 may generate an activation field group 744 that activates a machine-callable historical-data action for the customer-specific table.

In this manner, the activation field group resolver 712 converts archive view metadata and relationship metadata into one or more activation field groups 744 that are suitable for generating externally discoverable historical-data actions. The activation field groups 744 are therefore not merely visual link conditions for a rendered user interface, but may also operate as machine-readable preconditions for invoking historical-data actions.

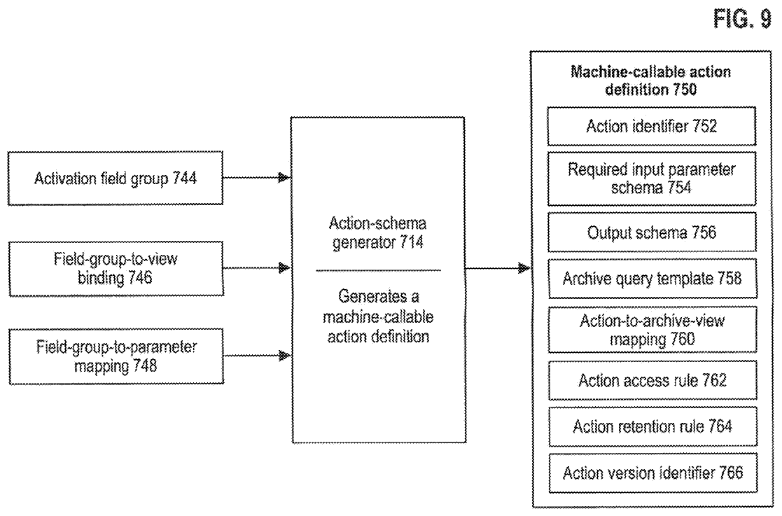

FIG. 9 depicts generation of machine-callable action definitions from activation field groups, according to an additional example embodiment. An action-schema generator 714 may receive or access one or more activation field groups 744, one or more field-group-to-view bindings 746, and one or more field-group-to-parameter mappings 748. Based on this information, the action-schema generator 714 may generate one or more machine-callable action definitions 750.

A machine-callable action definition 750 may describe a historical-data action that can be invoked by a consuming enterprise system 720. The machine-callable action definition 750 may comprise an action identifier 752, a required input parameter schema 754, an output schema 756, an archive query template 758, an action-to-archive-view mapping 760, an action access rule 762, an action retention rule 764, and an action version identifier 766.

The action identifier 752 may uniquely identify a historical-data action. In some embodiments, the action identifier 752 is generated from a business-object name, an archive view name, a sub-view name, a tenant identifier, a source-system identifier, a field-group identifier, or a combination thereof. In an example embodiment, the action identifier 752 may identify an action for retrieving historical sales order items, historical accounting document line items, historical customer master data, historical attachments, transformed archive objects, or customer-specific data from a custom table.

The required input parameter schema 754 may be generated from the activation field group 744. In particular embodiments, each field in the activation field group 744 is converted into a required input parameter of the machine-callable action definition 750. The required input parameter schema 754 may specify parameter names, data types, field lengths, formats, canonical field identifiers, source-system field identifiers, allowed values, conversion rules, and validation rules. In some embodiments, the required input parameter schema 754 also distinguishes required input parameters from optional input parameters.

The output schema 756 may be derived from the related archive view 734, from the field catalog of the related archive view 734, from a business-object definition, from an archive query result definition, or from a combination thereof. The output schema 756 may specify fields returned by the historical-data action, data types of returned fields, nested structures, arrays, table-like result sets, attachment metadata, document metadata, or links to additional historical-data actions.

The archive query template 758 may define how values supplied for the required input parameter schema 754 are used to query archived business data. The archive query template 758 may comprise a parameterized SQL query, an OData query template, a GraphQL query template, a stored-procedure invocation, an internal service route, an archive-index lookup, a transformed archive-object lookup, or another executable query representation. In some embodiments, the archive query template 758 is not exposed directly to the consuming enterprise system 720, but is instead used internally by the action execution gateway 718 or an archive query dispatcher.

The action-to-archive-view mapping 760 may bind the machine-callable action definition 750 to an archive view, sub-view, business-object view, table group, generated query, archive index, or other historical-data retrieval target. In particular embodiments, the action-to-archive-view mapping 760 is derived from the field-group-to-view binding 746. The action-to-archive-view mapping 760 may therefore preserve the relationship between a set of activation fields and the archive view or sub-view that becomes queryable when values for those activation fields are supplied.

The action access rule 762 may identify access conditions for invoking the machine-callable action definition 750. The action access rule 762 may comprise tenant restrictions, user-role restrictions, business-object authorization restrictions, field-level access restrictions, source-system restrictions, system-to-system trust restrictions, or other access-control requirements. In some embodiments, the action access rule 762 is generated from authorization metadata stored by the information management platform 702. In other embodiments, the action access rule 762 is inherited from an archive view, business object, tenant configuration, source system, or consuming-system trust relationship.

The action retention rule 764 may identify retention, deletion, legal hold, data residency, masking, privacy, or compliance constraints associated with the historical-data action. In some embodiments, the action retention rule 764 prevents an action from being generated, published, matched, invoked, or executed if archived data associated with the action is not permitted to be accessed. In other embodiments, the action retention rule 764 modifies the output schema 756, the archive query template 758, or the historical data result set returned by the action.

The action version identifier 766 may identify a version of the machine-callable action definition 750. The action version identifier 766 may be generated from a timestamp, hash, semantic version, catalog version, metadata version, source-system version, archive-view version, or a combination thereof. In some embodiments, the action version identifier 766 changes when the activation field group 744, required input parameter schema 754, output schema 756, action access rule 762, or action retention rule 764 changes.

In some embodiments, the action-schema generator 714 generates a plurality of machine-callable action definitions 750 from a single archive view. For example, a header-level archive view may give rise to a first machine-callable action for retrieving historical header data and a second machine-callable action for retrieving item-level or dependent historical data. In further embodiments, the action-schema generator 714 generates different machine-callable action definitions 750 for different activation field groups 744 associated with the same related archive view 734.

In some embodiments, the action-schema generator 714 suppresses generation of a machine-callable action definition 750 when no activation field group 744 is sufficient to query the corresponding archive view. In this manner, the generated action catalog 726 may include only historical-data actions that are actually invocable based on known field groups and relationships.

In this manner, the action-schema generator 714 transforms archive view metadata and activation field groups into machine-callable action definitions 750 that are suitable for publication, discovery, matching, validation, and runtime execution.

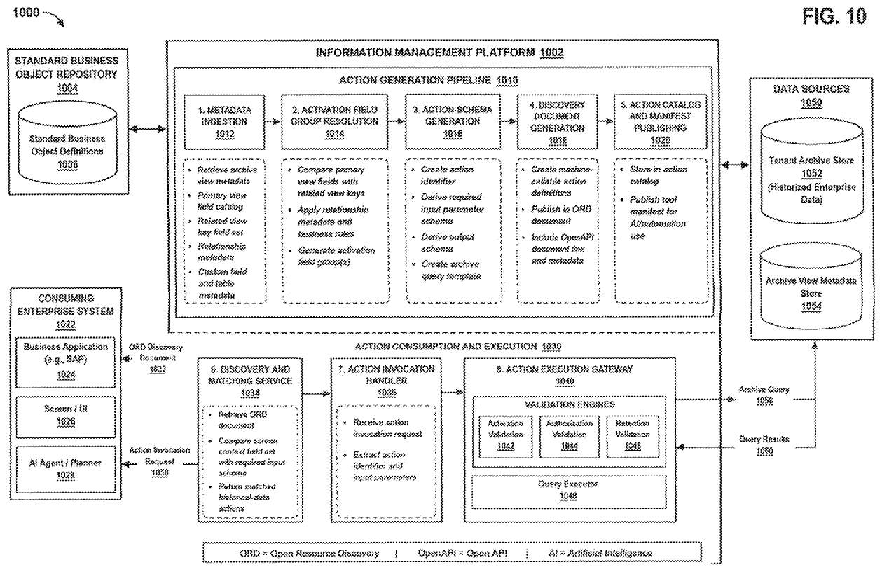

FIG. 10 depicts publication of generated action definitions through a resource discovery document, according to an additional example embodiment. In the embodiment of FIG. 10, an open resource discovery publication adapter 770 receives one or more machine-callable action definitions 750 from the generated action catalog 726 and generates an Open Resource Discovery document 772.

The open resource discovery publication adapter 770 may be implemented as part of the discovery-document generator 716, or as a separate adapter that converts an internal machine-readable discovery document 724 into a format compliant with an external discovery protocol. In preferred embodiments, the external discovery protocol is Open Resource Discovery. In other embodiments, the open resource discovery publication adapter 770 may generate another machine-readable resource discovery document, service description, API catalog entry, tool manifest, data product catalog entry, event catalog entry, or any combination thereof.

The Open Resource Discovery document 772 may comprise an Open Resource Discovery package 774. The Open Resource Discovery package 774 may group resources associated with a tenant, source system, retired application, archive object, business object, data product, integration scenario, or historical-data service. For example, a package 774 may group historical-data actions associated with a retired SAP system, with a particular business object such as a sales order or accounting document, or with a particular tenant archive store 704.

The Open Resource Discovery document 772 may further comprise one or more Open Resource Discovery entity type entries 776. An entity type entry 776 may correspond to a business object, archived business object, archive view, sub-view, transformed archive object, historical data object, or customer-specific business object. In some embodiments, the entity type entry 776 is generated from metadata retrieved by the archive metadata parser 706 and may include standard fields, custom fields, custom tables, or relationships associated with the corresponding historical enterprise data.

The Open Resource Discovery document 772 may further comprise one or more Open Resource Discovery API resource entries 778. An API resource entry 778 may correspond to one or more machine-callable action definitions 750. The API resource entry 778 may identify an action identifier 752, a location of an executable endpoint, a required input parameter schema 754, an output schema 756, or a link to a more detailed API description. In some embodiments, the API resource entry 778 does not merely describe a pre-existing manually authored API. Instead, the API resource entry 778 is generated from an activation field group 744, a field-group-to-parameter mapping 748, and an action-to-archive-view mapping 760.

The Open Resource Discovery document 772 may further comprise one or more Open Resource Discovery data product entries 780. A data product entry 780 may describe a set of historical enterprise data that is accessible through one or more machine-callable action definitions 750. For example, a data product entry 780 may describe historical sales orders, historical accounting documents, historical customer master data, historical attachments, transformed archive objects, customer-specific data, or audit evidence stored in or derived from the tenant archive store 704.

The Open Resource Discovery document 772 may further comprise an Open Resource Discovery access strategy 782. The access strategy 782 may identify how a consuming enterprise system 720 obtains access to one or more machine-callable action definitions 750. The access strategy 782 may include authentication requirements, authorization requirements, tenant restrictions, system-to-system trust requirements, token requirements, destination configuration, network location information, or other access information. In some embodiments, the access strategy 782 is generated or filtered based on the action access rule 762.

The Open Resource Discovery document 772 may further comprise an OpenAPI document link 784. The OpenAPI document link 784 may identify an OpenAPI document describing one or more generated historical-data actions. The OpenAPI document may comprise parameter definitions derived from the required input parameter schema 754 and response definitions derived from the output schema 756. In some embodiments, the OpenAPI document link 784 points to an OpenAPI document generated by the action-schema generator 714 or by the open resource discovery publication adapter 770.

A discovery document hash 786 may be generated for the Open Resource Discovery document 772 or for a portion thereof. The discovery document hash 786 may be used to detect changes, verify integrity, support caching, or determine whether a consuming enterprise system 720 should reload the Open Resource Discovery document 772. In some embodiments, the discovery document hash 786 is generated from the generated action catalog 726, the machine-callable action definitions 750, the action version identifiers 766, or a combination thereof.

A discovery document version 788 may identify a version of the Open Resource Discovery document 772. The discovery document version 788 may change when the generated action catalog 726 changes, when an activation field group 744 is added or removed, when a required input parameter schema 754 changes, when an output schema 756 changes, when an action access rule 762 changes, when an action retention rule 764 changes, or when tenant archive metadata changes.

In particular embodiments, the Open Resource Discovery document 772 is exposed through the open resource discovery endpoint 722. The open resource discovery endpoint 722 may respond to a discovery request from a consuming enterprise system 720 by providing the Open Resource Discovery document 772 or by providing a pointer to the Open Resource Discovery document 772. In some embodiments, the open resource discovery endpoint 722 provides a tenant-specific discovery document. In other embodiments, the open resource discovery endpoint 722 provides a filtered discovery document based on the identity, authorization, system context, or requested scope of the consuming enterprise system 720.

In this manner, the generated action catalog 726 may be published as a machine-readable discovery surface. The published discovery surface may describe only those historical-data actions that were generated from archive metadata and activation field groups. Thus, Open Resource Discovery is used as a publication format for action definitions generated by the historical action activation compiler 700, while the generation of the action definitions remains based on tenant-specific archive view metadata, field catalogs, relationship metadata, and activation field groups.

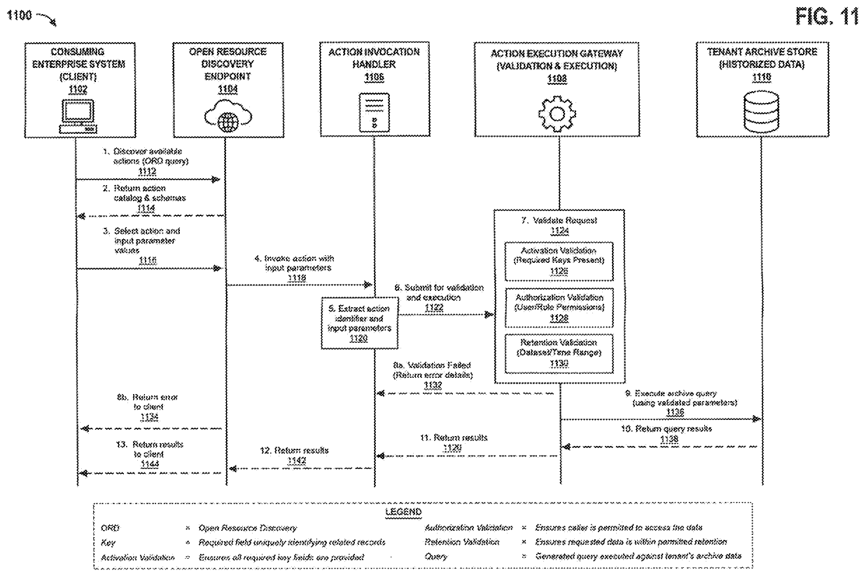

FIG. 11 depicts consumer-side discovery and context matching, according to an additional example embodiment. A consuming enterprise system 720 may comprise or communicate with an SAP system 790. The SAP system 790 may be an SAP S/4HANA system, SAP ERP system, SAP BTP tenant, SAP integration environment, SAP extension application, SAP user interface, SAP workflow environment, or another SAP-related system. In other embodiments, the consuming enterprise system 720 may be a non-SAP enterprise system.

The SAP system 790 may present or process an SAP business screen 792. The SAP business screen 792 may comprise a transaction screen, application screen, object page, list report, analytical page, workflow task, form, business-object display, or other user or system context in which one or more business fields are available. The SAP business screen 792 may be associated with a screen-context field set 794.

The screen-context field set 794 may comprise fields that are available to the SAP system 790 in a current context. The screen-context field set 794 may comprise visible screen fields, hidden technical fields, business-object key fields, user-selected row fields, URL parameters, routing parameters, workflow parameters, integration-message fields, or other context fields. In an example embodiment, the screen-context field set 794 comprises a company code, document number, and fiscal year. In another example embodiment, the screen-context field set 794 comprises a sales order number and item number. In a further example embodiment, the screen-context field set 794 comprises one or more custom fields.

The consuming enterprise system 720 may retrieve the machine-readable discovery document 724 from the open resource discovery endpoint 722. The machine-readable discovery document 724 may identify one or more machine-callable action definitions 750 generated by the historical action activation compiler 700. Each machine-callable action definition 750 may comprise or reference a required input parameter schema 754 that was generated from an activation field group 744.

An action matching service 796 may compare the screen-context field set 794 with one or more required input parameter schemas 754. The action matching service 796 may be implemented in the consuming enterprise system 720, in the SAP system 790, in the information management platform 702, in a browser extension, in an integration platform, in a workflow environment, or in another computing component. In some embodiments, the action matching service 796 receives the screen-context field set 794 from the SAP business screen 792 and receives the machine-callable action definitions 750 from the machine-readable discovery document 724.

The action matching service 796 may determine whether the screen-context field set 794 contains values corresponding to all required input parameters of a machine-callable action definition 750. If the screen-context field set 794 contains such values, the action matching service 796 may determine that the corresponding historical-data action is callable from the current context. If the screen-context field set 794 lacks one or more required values, the action matching service 796 may omit the corresponding historical-data action, mark the corresponding historical-data action as unavailable, or request additional input.

The action matching service 796 may generate a matched historical-data action list 798. The matched historical-data action list 798 may comprise one or more machine-callable action definitions 750 for which the screen-context field set 794 satisfies the corresponding activation field group 744 or required input parameter schema 754. The matched historical-data action list 798 may be displayed to a user, supplied to an integration process, supplied to an artificial-intelligence planner, or used automatically by the consuming enterprise system 720.

A selected historical-data action 800 may be selected from the matched historical-data action list 798. The selected historical-data action 800 may be selected by a user, by a workflow, by a rule engine, by an integration process, by an artificial-intelligence planner, or by another software component. Selection of the selected historical-data action 800 may cause the consuming enterprise system 720 to generate an action invocation request directed to the action execution gateway 718.

In some embodiments, the action matching service 796 may perform field-name normalization before comparing the screen-context field set 794 with the required input parameter schema 754. Such normalization may include mapping a source-system field name to a canonical field name, mapping an SAP field name to an action parameter name, converting a custom field name, converting a data type, applying a formatting rule, or applying a field-group-to-parameter mapping 748.

In further embodiments, the action matching service 796 may consider action access rules 762 or action retention rules 764 when generating the matched historical-data action list 798. For example, a historical-data action may be omitted from the matched historical-data action list 798 if the consuming enterprise system 720 lacks authorization to invoke the action or if a retention rule prohibits access to the corresponding archived data.

In this manner, a consuming enterprise system 720 can determine, based on a machine-readable discovery document 724 and a current screen-context field set 794, which historical-data actions generated from activation field groups 744 are callable from a current enterprise context. The consuming enterprise system 720 need not be manually programmed with tenant-specific knowledge of each archive view, sub-view, custom field, custom table, or activation field group.

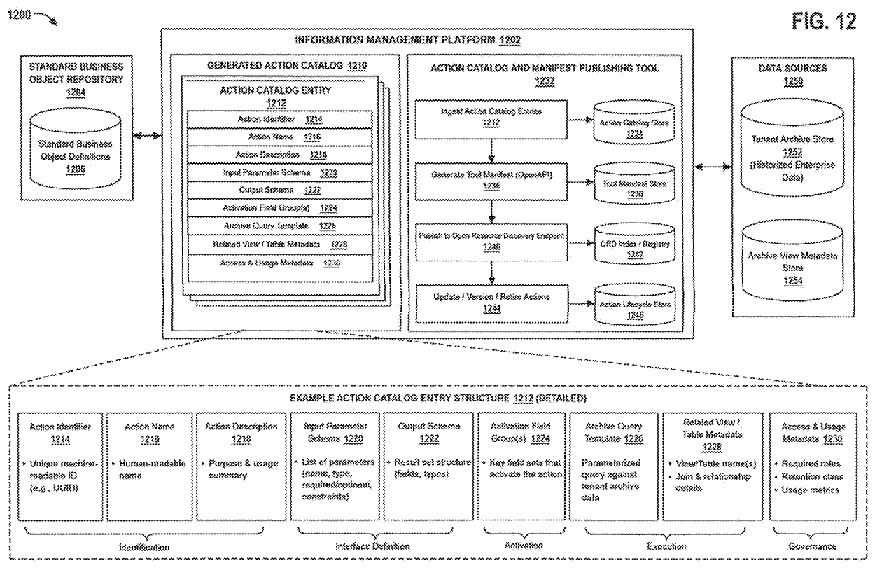

FIG. 12 depicts runtime validation and execution of a generated historical-data action, according to an additional example embodiment. An action invocation request 810 may be received by the action execution gateway 718. The action invocation request 810 may identify a selected historical-data action 800 or a machine-callable action definition 750 and may include one or more parameter values supplied by a consuming enterprise system 720.

The action invocation request 810 may comprise an action identifier 752, one or more parameter names, one or more parameter values, a tenant identifier, a user identifier, a consuming-system identifier, a session identifier, a source-system identifier, an authorization token, a requested output format, or any combination thereof. In some embodiments, the action invocation request 810 is generated from fields available in a screen-context field set 794. In other embodiments, the action invocation request 810 is generated by an integration process, workflow process, service call, artificial-intelligence planner, or other software component.

The action execution gateway 718 may comprise or communicate with an activation validation engine 812. The activation validation engine 812 may retrieve the machine-callable action definition 750 corresponding to the action identifier 752. The activation validation engine 812 may determine the activation field group 744 or required input parameter schema 754 corresponding to the invoked action. The activation validation engine 812 may then determine whether the action invocation request 810 includes values corresponding to the fields of the activation field group 744 or to the required parameters of the required input parameter schema 754.

If the action invocation request 810 omits a required value, includes a value of an invalid type, includes a value having an invalid format, includes a value outside an allowed range, or otherwise fails to satisfy the activation field group 744, the activation validation engine 812 may cause the action execution gateway 718 to return a rejected invocation response 818. The rejected invocation response 818 may identify one or more missing fields, invalid fields, invalid formats, required parameters, remediation instructions, or links to discovery metadata.

If the action invocation request 810 satisfies the activation field group 744, the action execution gateway 718 may perform further validation. In some embodiments, an authorization validation engine 814 validates whether the user, tenant, consuming enterprise system 720, or calling process is authorized to invoke the selected historical-data action 800. The authorization validation engine 814 may evaluate an action access rule 762, a tenant authorization rule, a user role, a business-object authorization, a field-level authorization, a source-system authorization, a trust relationship, or any combination thereof.

In some embodiments, a retention validation engine 816 validates whether the selected historical-data action 800 is permitted under one or more retention, deletion, legal hold, privacy, masking, residency, or compliance constraints. The retention validation engine 816 may evaluate an action retention rule 764. The retention validation engine 816 may determine whether the requested historical-data action is prohibited, whether one or more output fields must be masked, whether a reduced output schema must be used, whether a legal-hold exception applies, or whether the request must be logged for compliance purposes.

If the authorization validation engine 814 or the retention validation engine 816 determines that the action invocation request 810 is not permitted, the action execution gateway 718 may return a rejected invocation response 818. The rejected invocation response 818 may indicate that authorization failed, that a retention rule prevented execution, that access to one or more fields is restricted, that a masking rule applies, or that additional approval is required.

If the action invocation request 810 satisfies activation validation, authorization validation, and retention validation, the action execution gateway 718 may provide the request to an archive query dispatcher 820. The archive query dispatcher 820 may select or generate a generated archive query 822 using the archive query template 758, the action-to-archive-view mapping 760, and the parameter values from the action invocation request 810.

The generated archive query 822 may comprise a SQL query, OData query, GraphQL query, stored-procedure call, archive-index lookup, internal service request, file-based archive lookup, transformed archive-object lookup, or other executable retrieval instruction. The generated archive query 822 may be parameterized so that values from the action invocation request 810 are bound to parameters corresponding to the activation field group 744.

The archive query dispatcher 820 may execute the generated archive query 822 against the tenant archive store 704 or against a service associated with the tenant archive store 704. In some embodiments, the archive query dispatcher 820 queries one or more relational tables. In other embodiments, the archive query dispatcher 820 queries an archive index, transformed archive object, document store, object store, file-based archive, or combination thereof.

Execution of the generated archive query 822 may produce a historical data result set 824. The historical data result set 824 may comprise one or more records, rows, documents, attachments, object instances, nested objects, table-like results, metadata records, or links to further historical-data actions. The historical data result set 824 may be formatted according to the output schema 756 associated with the selected historical-data action 800.

The action execution gateway 718 may generate an invocation audit log 826. The invocation audit log 826 may identify the action identifier 752, the action version identifier 766, the activation field group 744, the parameter values or masked parameter values, the tenant identifier, the consuming enterprise system 720, the user or process that invoked the action, the generated archive query 822 or a query identifier, the validation result, the execution result, a timestamp, or any combination thereof.

In some embodiments, the invocation audit log 826 records both successful and rejected invocations. In further embodiments, the invocation audit log 826 records whether an action invocation request 810 was rejected by the activation validation engine 812, the authorization validation engine 814, or the retention validation engine 816.

In this manner, the action execution gateway 718 uses the same activation field group 744 that was used to generate and publish the machine-callable action definition 750 as a runtime validation structure. Accordingly, a historical-data action is not merely described for discovery purposes, but is also enforced at execution time against the activation field group 744, access rules, and retention rules associated with the generated action.

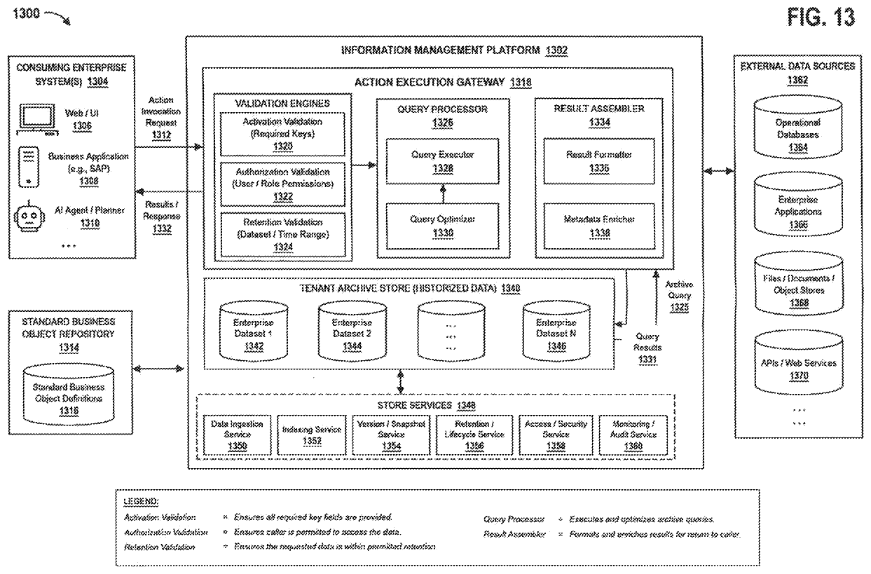

FIG. 13 depicts an optional artificial-intelligence consumer of generated action definitions, according to an additional example embodiment. An artificial-intelligence planner 830 may consume one or more machine-callable action definitions 750 generated by the historical action activation compiler 700. The artificial-intelligence planner 830 may be implemented as or comprise a large language model, machine-learning model, rules-based planner, retrieval-augmented generation system, agent framework, orchestration engine, workflow planner, or other software component configured to select or propose actions.

In some embodiments, the artificial-intelligence planner 830 is implemented in the consuming enterprise system 720. In other embodiments, the artificial-intelligence planner 830 is implemented in the information management platform 702, in a cloud service, in an integration platform, in an SAP extension environment, in a workflow environment, or in another computing environment. The artificial-intelligence planner 830 may receive the machine-readable discovery document 724, the Open Resource Discovery document 772, one or more OpenAPI documents referenced by the OpenAPI document link 784, or a generated tool manifest 832.

The generated tool manifest 832 may be generated from one or more machine-callable action definitions 750. The generated tool manifest 832 may identify one or more historical-data actions that may be selected by the artificial-intelligence planner 830. For each such action, the generated tool manifest 832 may identify an action identifier 752, a required input parameter schema 754, an output schema 756, an action access rule 762, an action retention rule 764, and a description of the historical-data action. In some embodiments, the generated tool manifest 832 is generated from the same generated action catalog 726 that is used by the discovery-document generator 716 and the action execution gateway 718.

The artificial-intelligence planner 830 may further receive generated prompt context 834. The generated prompt context 834 may comprise natural-language or structured descriptions of historical-data actions, available input parameters, allowed output fields, tenant-specific limitations, source-system lineage, custom fields, custom tables, retention constraints, access constraints, or examples of valid action invocations. In some embodiments, the generated prompt context 834 is generated from the machine-callable action definitions 750 and is limited to actions that are available to a particular consuming enterprise system 720 or user.

The artificial-intelligence planner 830 may generate a proposed agent action 836. The proposed agent action 836 may identify a selected historical-data action 800 and may include parameter values that the artificial-intelligence planner 830 determined from a user request, an SAP business screen 792, a screen-context field set 794, a workflow context, an integration message, or another source of context.

In particular embodiments, the artificial-intelligence planner 830 is constrained to select only historical-data actions that are present in the generated tool manifest 832 or in the machine-readable discovery document 724. In further embodiments, the artificial-intelligence planner 830 is configured to refrain from generating a proposed agent action 836 when the required input parameter schema 754 of a machine-callable action definition 750 cannot be satisfied from available context or user-provided values.

The proposed agent action 836 may be provided to the action execution gateway 718. The action execution gateway 718 may validate the proposed agent action 836 in the same manner as other action invocation requests. In particular, the activation validation engine 812 may determine whether the proposed agent action 836 includes values corresponding to the activation field group 744 or required input parameter schema 754 of the selected historical-data action 800. The authorization validation engine 814 may determine whether the proposed agent action 836 is permitted under the action access rule 762. The retention validation engine 816 may determine whether the proposed agent action 836 is permitted under the action retention rule 764.

If the proposed agent action 836 satisfies the applicable validation rules, the action execution gateway 718 may treat the proposed agent action 836 as a validated agent action 838. The validated agent action 838 may then be executed by the archive query dispatcher 820 using a generated archive query 822. The resulting historical data result set 824 may be returned to the artificial-intelligence planner 830, to the consuming enterprise system 720, to the SAP system 790, to a user interface, or to another software component.

If the proposed agent action 836 fails activation validation, authorization validation, retention validation, or any other validation rule, the action execution gateway 718 may treat the proposed agent action 836 as a rejected agent action 840. The rejected agent action 840 may cause the action execution gateway 718 to return a rejected invocation response 818. The rejected invocation response 818 may identify missing parameters, invalid fields, unauthorized actions, prohibited output fields, retention restrictions, or remediation instructions.

In some embodiments, the artificial-intelligence planner 830 is not permitted to directly execute archive queries against the tenant archive store 704. Instead, the artificial-intelligence planner 830 may invoke historical-data actions only through machine-callable action definitions 750 generated by the historical action activation compiler 700 and enforced by the action execution gateway 718. In this manner, the artificial-intelligence planner 830 may consume generated discovery metadata while runtime execution remains constrained by activation field groups 744 and by the validation engines of the action execution gateway 718.

In some embodiments, the artificial-intelligence planner 830 may generate a natural-language answer based on the historical data result set 824. The natural-language answer may include provenance information identifying the selected historical-data action 800, the action identifier 752, the action version identifier 766, the archive view queried, or the source-system lineage of the returned data. In further embodiments, the artificial-intelligence planner 830 may be instructed to state that no action is available when no machine-callable action definition 750 satisfies the current context.

In this manner, artificial-intelligence functionality is layered on top of the generated historical-data action surface. The artificial-intelligence planner 830 may select or propose actions, but the existence of the actions, the required input parameters, the output schemas, and the runtime validation rules are generated from archive metadata and activation field groups by the historical action activation compiler 700.

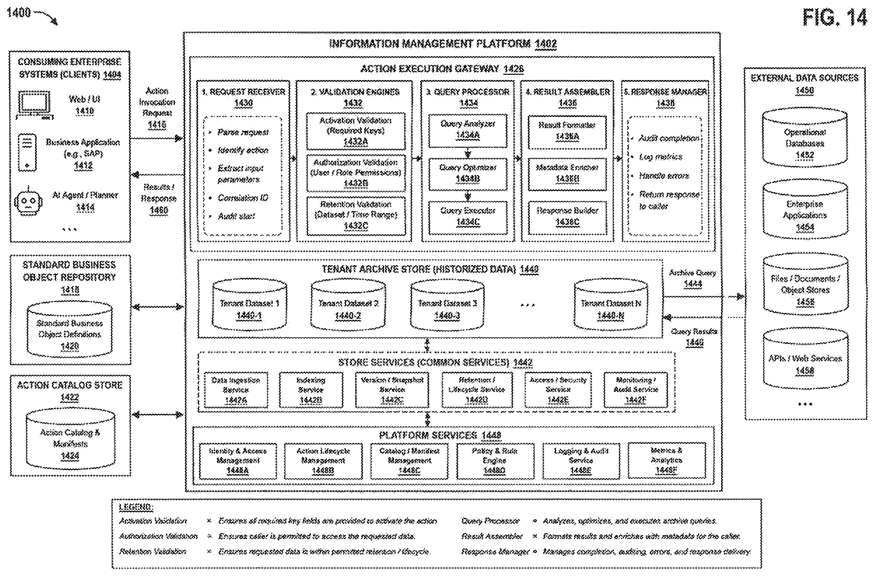

FIG. 14 depicts metadata-change detection and regeneration of generated action definitions and resource discovery documents, according to an additional example embodiment. In the embodiment of FIG. 14, a metadata change detector 850 may monitor, poll, receive, or otherwise detect changed archive view metadata 852.

The changed archive view metadata 852 may comprise a change to a field catalog, a change to a related view key field set, a change to relationship metadata, a change to custom field metadata, a change to custom table metadata, a change to an archive view, a change to a sub-view, a change to an archive query template, a change to an access rule, a change to a retention rule, a change to source-system lineage metadata, or any combination thereof.

The metadata change detector 850 may be implemented as part of the information management platform 702, the tenant archive store 704, the archive view metadata store 710, the historical action activation compiler 700, or another component. In some embodiments, the metadata change detector 850 detects changes when new archived business data is loaded into the tenant archive store 704. In other embodiments, the metadata change detector 850 detects changes when a business object is activated, when a custom field or custom table is added, when a relationship is discovered, when an archive view is regenerated, when a retention rule changes, or when an access rule changes.

In response to detecting changed archive view metadata 852, the historical action activation compiler 700 may re-run the activation field group resolver 712 for one or more affected archive views. The activation field group resolver 712 may generate a regenerated activation field group 854. The regenerated activation field group 854 may be newly created, modified, or removed relative to a previously generated activation field group 744.

In some embodiments, the historical action activation compiler 700 determines whether the changed archive view metadata 852 affects a previously generated machine-callable action definition 750. For example, if a required key field is removed from a related archive view, a previously generated action may no longer be valid. If a new custom field is added to a primary archive view and the new custom field completes a key field set for a related archive view, a new historical-data action may become generatable. If a retention rule changes, an existing historical-data action may remain present but may require a changed output schema, changed access rule, masking rule, or rejection rule.

A deprecated action marker 856 may be applied to a machine-callable action definition 750 that is no longer valid, no longer executable, no longer authorized, no longer permitted by retention rules, or superseded by a regenerated action. The deprecated action marker 856 may be included in the generated action catalog 726, the machine-readable discovery document 724, the Open Resource Discovery document 772, or an internal action registry. In some embodiments, an action marked with the deprecated action marker 856 remains discoverable for a limited time but is not executable. In other embodiments, the action is removed from newly generated discovery documents.

The historical action activation compiler 700 may generate a regenerated action catalog 858. The regenerated action catalog 858 may comprise new machine-callable action definitions 750, modified machine-callable action definitions 750, unchanged machine-callable action definitions 750, and machine-callable action definitions 750 marked with deprecated action markers 856. The regenerated action catalog 858 may include updated action version identifiers 766.

The discovery-document generator 716 or open resource discovery publication adapter 770 may generate a regenerated Open Resource Discovery document 860 based on the regenerated action catalog 858. The regenerated Open Resource Discovery document 860 may include updated Open Resource Discovery entity type entries 776, updated Open Resource Discovery API resource entries 778, updated Open Resource Discovery data product entries 780, updated Open Resource Discovery access strategies 782, updated OpenAPI document links 784, an updated discovery document hash 786, or an updated discovery document version 788.

A revalidation job 862 may be triggered when the regenerated action catalog 858 or regenerated Open Resource Discovery document 860 is generated. The revalidation job 862 may identify existing integrations, cached discovery documents, generated tool manifests, artificial-intelligence planner configurations, workflows, user-interface extensions, or consuming enterprise systems that reference a changed, deprecated, or removed machine-callable action definition 750. The revalidation job 862 may notify such components, refresh cached metadata, disable unavailable actions, regenerate tool manifests, or require re-approval of affected actions.

In some embodiments, the revalidation job 862 revalidates stored action invocation templates against regenerated activation field groups 854. If a stored invocation template lacks a newly required parameter, the revalidation job 862 may mark the invocation template invalid. If a stored invocation template references a deprecated action, the revalidation job 862 may identify a replacement action or return a remediation instruction.

In further embodiments, the regenerated Open Resource Discovery document 860 is exposed through the open resource discovery endpoint 722. A consuming enterprise system 720 may use the discovery document hash 786 or discovery document version 788 to determine whether a previously retrieved discovery document is stale. The consuming enterprise system 720 may then retrieve the regenerated Open Resource Discovery document 860 and update a matched historical-data action list 798, generated tool manifest 832, or other local action representation.

In this manner, the machine-callable historical-data action surface remains synchronized with tenant-specific archive metadata. The publication of machine-callable action definitions 750 is not merely a static documentation exercise. Instead, the action definitions, discovery documents, validation rules, and executable archive queries may be regenerated or invalidated in response to changes in archive view metadata, business-object metadata, custom-field metadata, custom-table metadata, relationship metadata, access rules, or retention rules.

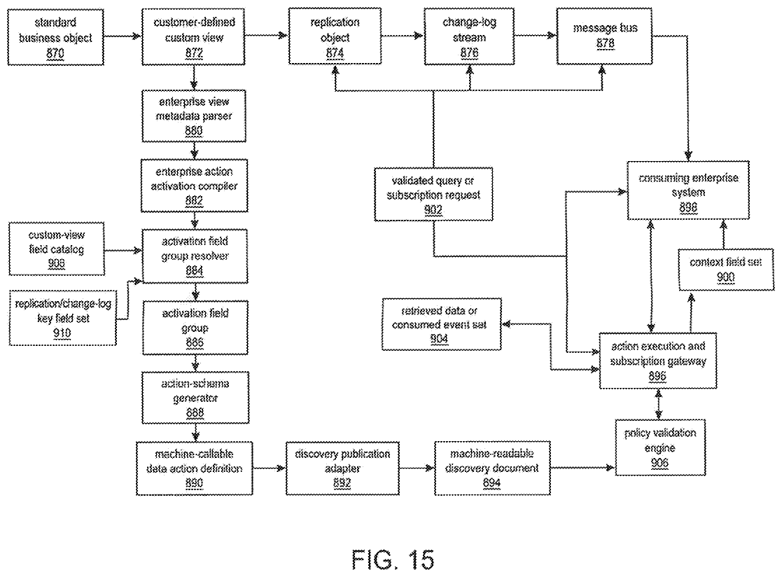

FIG. 15 depicts generation of discoverable machine-callable data actions from customer-defined custom views, replication objects, and change-log resources, according to an additional example embodiment. A standard business object 870 may be represented in a production or operational enterprise system. A customer-defined custom view 872 may expose a subset of fields of the standard business object 870, one or more renamed fields, one or more calculated fields, one or more customer-specific fields, one or more joined fields, or any combination thereof.

In some embodiments, the customer-defined custom view 872 is associated with or gives rise to a replication object 874. The replication object 874 may store a representation of data exposed through the customer-defined custom view 872. A change-log stream 876 may record create, update, delete, insert, modify, or other changes associated with the replication object 874, the customer-defined custom view 872, or the standard business object 870. In further embodiments, the change-log stream 876 may be transmitted or exposed through a message bus 878.

An enterprise view metadata parser 880 may retrieve metadata associated with the customer-defined custom view 872, the replication object 874, the change-log stream 876, or the message bus 878. The metadata may include a custom-view field catalog 908 and a replication/change-log key field set 910. The enterprise action activation compiler 882 may use the custom-view field catalog 908 and the replication/change-log key field set 910 to determine whether a set of fields is sufficient to query, retrieve, subscribe to, consume, or otherwise access the replication object 874, the change-log stream 876, or a resource accessible through the message bus 878.

An activation field group resolver 884 may compare the custom-view field catalog 908 with the replication/change-log key field set 910 and may generate an activation field group 886. The activation field group 886 may identify one or more fields sufficient to activate a machine-callable data action directed to the replication object 874, the change-log stream 876, or another related enterprise resource.

An action-schema generator 888 may generate a machine-callable data action definition 890 from the activation field group 886. The machine-callable data action definition 890 may define a query action, retrieval action, subscription action, event-consumption action, export action, or other data action. A discovery publication adapter 892 may publish the machine-callable data action definition 890 in a machine-readable discovery document 894.

A consuming enterprise system 898 may retrieve the machine-readable discovery document 894 and may determine, based on a context field set 900, whether the machine-callable data action definition 890 is invocable. An action execution and subscription gateway 896 may receive a request corresponding to the machine-callable data action definition 890 and may use a policy validation engine 906 to validate the request before issuing a validated query or subscription request 902. The validated query or subscription request 902 may retrieve data from the replication object 874, consume data from the change-log stream 876, receive data from the message bus 878, or otherwise access a resource corresponding to the machine-callable data action definition 890. A retrieved data or consumed event set 904 may then be returned.

In this manner, the activation-field-group-based action generation techniques described herein may be applied to customer-defined custom views, replication objects, change-log streams, and message-bus resources, in addition to archive views and historized data stores.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above detailed description describes various features and functions of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the diagrams, scenarios, and flow charts in the figures and as discussed herein, each block and/or communication can represent a processing of information and/or a transmission of information in accordance with example embodiments. Alternative embodiments are included within the scope of these example embodiments. In these alternative embodiments, for example, functions described as blocks, transmissions, communications, requests, responses, and/or messages can be executed out of order from that shown or discussed, including substantially concurrent or in reverse order, depending on the functionality involved. Further, more or fewer blocks and/or functions can be used with any of the diagrams, scenarios, and flow charts discussed herein, and these diagrams, scenarios, and flow charts can be combined with one another, in part or in whole.

A block that represents a processing of information can correspond to circuitry that can be configured to perform the specific logical functions of a herein-described method or technique. Alternatively or additionally, a block that represents a processing of information can correspond to a module, a segment, or a portion of program code (including related data). The program code can include one or more instructions executable by a processor for implementing specific logical functions or actions in the method or technique. The program code and/or related data can be stored on any type of computer readable medium such as a storage device including a disk or hard drive or other storage medium.

The computer readable medium can also include non-transitory computer readable media such as computer-readable media that stores data for short periods of time like register memory, processor cache, and random access memory (RAM). The computer readable media can also include non-transitory computer readable media that stores program code and/or data for longer periods of time, such as secondary or persistent long term storage, like read only memory (ROM), optical or magnetic disks, or compact-disc read only memory (CD-ROM), for example. The computer readable media can also be any other volatile or non-volatile storage systems. A computer readable medium can be considered a computer readable storage medium, for example, or a tangible storage device.

Moreover, a block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### DEFINITIONS AND CLARIFICATIONS

Herein below are a few definitions and clarifications. As used herein:

The terms “a” and “an”, when modifying a noun, do not imply that only one of the noun exists.

The term “comprise” (and grammatical variations thereof) shall be construed broadly, as if followed by “Without limitation”. If A comprises B, then A includes B and may include other things.

The term “e. g.” means including without limitation. The fact that an “example” or multiple examples of something are given does not imply that they are the only instances of that thing. An example (or a group of examples) is merely a non-exhaustive and non-limiting illustration.

The term “include” (and grammatical variations thereof) shall be construed broadly, as if followed by “Without limitation”.

The term “or” is an inclusive disjunctive. For example “A or B” is true if A is true, or B is true, or both A or B are true.

A parenthesis is simply to make text easier to read, by indicating a grouping of words. A parenthesis does not mean that the parenthetical material is optional or can be ignored.

### Operational and Replicated Enterprise View Embodiments

Although many embodiments described herein refer to archive views, related archive views, tenant archive stores, and historized enterprise data, the techniques are not limited to archived or historized data. In additional embodiments, the historical action activation compiler 700 may operate as an enterprise action activation compiler for generating machine-callable data actions from production views, operational views, replicated views, customer-defined custom views, change-log views, staging views, migration views, analytical views, or other enterprise data views.

In such embodiments, a tenant archive store 704 may be replaced by, supplemented by, or operated together with an enterprise data store. The enterprise data store may comprise a production database, operational database, replication object store, change-log store, event store, message-bus topic, staging database, migration database, data warehouse, data lake, or other enterprise data repository. A primary archive view 730 may be replaced by or supplemented with a primary enterprise data view. A related archive view 734 may be replaced by or supplemented with a related enterprise data view.

In some embodiments, the primary enterprise data view comprises a customer-defined custom view on a standard business object. The customer-defined custom view may expose a subset of fields, a renamed field set, a joined field set, a calculated field, a customer-specific field, a custom table field, or a combination thereof. The activation field group resolver 712 may compare a field catalog of the customer-defined custom view with a key field set of a related enterprise data view, replication object, change-log view, event stream, or other related resource. If the comparison indicates that the customer-defined custom view contains fields sufficient to query, subscribe to, or otherwise consume the related resource, the activation field group resolver 712 may generate an activation field group 744.

In further embodiments, the action-schema generator 714 may generate a machine-callable action definition 750 for an operational or replicated enterprise data action. The machine-callable action definition 750 may comprise an action identifier 752, a required input parameter schema 754, an output schema 756, an enterprise query template, a subscription template, an event-consumption template, or a change-log-consumption template. The generated action may be configured to query a production view, invoke a service associated with a custom view, retrieve records from a replication object, subscribe to change logs, consume events from a message bus, or retrieve a current or historical state of an enterprise object.

In still further embodiments, the discovery-document generator 716 may publish the machine-callable action definition 750 in a machine-readable discovery document 724 so that a consuming enterprise system 720 can automatically discover data actions available from the production view, operational view, replicated view, customer-defined custom view, change-log view, or event stream. The machine-readable discovery document 724 may be an Open Resource Discovery document 772 or another machine-readable discovery document.

In such embodiments, the action execution gateway 718 may validate an action invocation request 810 before executing a query, invoking a service, retrieving data from a replication object, or subscribing to a change-log or event stream. The activation validation engine 812 may validate that the action invocation request 810 contains values corresponding to the activation field group 744. The authorization validation engine 814 may validate that the caller is authorized to access the relevant enterprise data view, replication object, or change-log stream. The retention validation engine 816 may be replaced by or supplemented with a policy validation engine configured to validate lifecycle, privacy, residency, masking, usage, or event-consumption policies.

In this manner, the same activation-field-group-based action generation mechanism may be applied both to historized enterprise data and to operational enterprise data. The invention therefore includes embodiments in which machine-callable actions are generated from archive views, production views, replicated views, customer-defined custom views, or change-log views, provided that the actions are generated from field catalogs, key field sets, relationship metadata, and activation field groups and are validated before execution or consumption.

### ADDITIONAL DEFINITIONS AND CLARIFICATIONS

As used herein, an “enterprise data store” means a production database, archive database, operational database, replication object store, change-log store, event store, message-bus topic, staging database, migration database, data warehouse, data lake, or other repository storing enterprise data.

As used herein, an “enterprise data view” means an archive view, production view, operational view, replicated view, customer-defined custom view, analytical view, staging view, migration view, change-log view, event view, or other machine-addressable view of enterprise data.

As used herein, a “machine-callable data action” means a machine-callable action for querying, retrieving, subscribing to, consuming, exporting, or otherwise accessing enterprise data. A machine-callable historical-data action is one example of a machine-callable data action.

As used herein, a “historical action activation compiler” 700 means a program, module, service, or other computer-implemented component that has access to archive view metadata, business-object metadata, field catalogs, relationship metadata, standard business-object definitions, tenant-specific customization metadata, or any combination thereof, and that automatically or semi-automatically determines one or more activation field groups 744 for generating machine-callable historical-data actions.

As used herein, an “activation field group” 744 means a set of one or more fields that is sufficient to activate, invoke, query, link to, or otherwise access an archive view, sub-view, related business-object view, historical lookup, transformed archive object, archive-index lookup, or other historical-data action. An activation field group 744 may comprise standard fields, custom fields, technical fields, generated fields, archive-object fields, index fields, primary-key fields, foreign-key fields, or any combination thereof.

As used herein, a “machine-callable action definition” 750 means a machine-readable definition of an executable or invocable historical-data action. A machine-callable action definition 750 may comprise an action identifier 752, a required input parameter schema 754, an output schema 756, an archive query template 758, an action-to-archive-view mapping 760, an action access rule 762, an action retention rule 764, an action version identifier 766, or any combination thereof.

As used herein, a “machine-readable discovery document” 724 means a computer-readable document, file, response, manifest, catalog entry, resource description, service description, or other data structure that describes one or more resources, APIs, actions, entity types, data products, events, access strategies, schemas, or relationships in a format that can be processed by a consuming enterprise system 720. A machine-readable discovery document 724 may be an Open Resource Discovery document 772, an OpenAPI document, an OData metadata document, a GraphQL schema, an AsyncAPI document, a tool manifest, a data-product catalog entry, or another machine-readable description.

As used herein, an “open resource discovery endpoint” 722 means a network endpoint configured to provide, identify, locate, or reference a machine-readable discovery document 724. In some embodiments, an open resource discovery endpoint 722 may be implemented as, or may include, a well-known discovery endpoint. In other embodiments, an open resource discovery endpoint 722 may be implemented as a tenant-specific endpoint, service endpoint, API endpoint, catalog endpoint, or discovery service.

As used herein, an “action execution gateway” 718 means a computer-implemented gateway, service, module, proxy, controller, dispatcher, or interface that receives an action invocation request 810 for a machine-callable action definition 750 and performs at least activation validation before causing an archive query to be executed against a tenant archive store 704.

As used herein, an “action invocation request” 810 means a request, message, API call, service call, event, instruction, agent action, workflow step, integration call, or other machine-generated or user-generated invocation that requests execution of a machine-callable action definition 750.

As used herein, a “tenant archive store” 704 means any database, archive database, file store, object store, document store, archive index, transformed archive-object store, historized data store, data lake, data warehouse, or other data repository that stores archived, retired, historized, migrated, transformed, or otherwise preserved enterprise data for a tenant, customer, organization, system, source system, or combination thereof.

As used herein, a “screen-context field set” 794 means a set of fields or field values available in a current context of a consuming enterprise system 720. A screen-context field set 794 may include fields displayed on a user interface screen, hidden technical fields, selected row fields, object-page fields, transaction fields, route parameters, workflow fields, integration-message fields, session fields, or any combination thereof.

As used herein, a “generated tool manifest” 832 means a machine-readable description of one or more machine-callable action definitions 750 that may be supplied to an artificial-intelligence planner 830, agent framework, workflow engine, integration engine, or other software component for selecting, proposing, validating, or invoking historical-data actions.

As used herein, “historized enterprise data” means enterprise data that has been archived, retired, extracted, transformed, migrated, carved out, preserved, stored for audit purposes, stored for compliance purposes, stored for read-only access, or otherwise separated from a production enterprise application while remaining accessible through an information management platform 702.

As used herein, “Open Resource Discovery” and “ORD” refer to a machine-readable resource discovery technology or protocol that may be used to describe resources, APIs, entity types, packages, data products, events, access strategies, or related metadata. References to Open Resource Discovery are illustrative and non-limiting. The inventions described herein may be implemented using Open Resource Discovery, another resource discovery protocol, another service description format, or a proprietary discovery format.

1. A computer-implemented system for generating discoverable machine-callable data actions, the system comprising:
an enterprise data store storing enterprise data;
an enterprise view metadata parser configured to retrieve view metadata associated with the enterprise data store, the view metadata comprising at least a custom-view field catalog of a customer-defined custom view on a standard business object and a related-resource key field set of a related enterprise resource;
an activation field group resolver configured to compare the custom-view field catalog with the related-resource key field set and to generate an activation field group identifying one or more fields sufficient to query, retrieve, subscribe to, or consume data from the related enterprise resource;
an action-schema generator configured to generate, from the activation field group, a machine-callable data action definition comprising an action identifier and a required input parameter schema derived from the activation field group;
a publication interface configured to store or publish the machine-callable data action definition in at least one of an action catalog or a machine-readable discovery document; and
an action execution gateway configured to receive an action invocation request identifying the machine-callable data action definition and to issue a validated query, retrieval request, subscription request, or consumption request for the related enterprise resource only after validating that the action invocation request includes values corresponding to the required input parameter schema.

2. The system of claim 1, wherein the related enterprise resource comprises at least one of a replication object, a change-log stream, a message-bus topic, an event stream, a production view, an operational view, an archive view, or a related customer-defined custom view.

3. The system of claim 1, wherein the customer-defined custom view comprises at least one of a subset of fields of the standard business object, a renamed field, a calculated field, a joined field, a custom field, or a field from a custom table.

4. The system of claim 1, wherein the related enterprise resource comprises a replication object configured to represent data exposed through the customer-defined custom view.

5. The system of claim 1, wherein the related enterprise resource comprises a change-log stream recording create, update, delete, insert, modify, or destroy operations associated with the standard business object, the customer-defined custom view, or a replication object.

6. The system of claim 1, wherein the machine-callable data action definition defines at least one of a query action, retrieval action, subscription action, event-consumption action, export action, or change-log-consumption action.

7. The system of claim 1, wherein the machine-callable data action definition further comprises at least one of an output schema, a query template, a subscription template, an event-consumption template, an action access rule, an action policy rule, or an action version identifier.

8. The system of claim 1, wherein the machine-readable discovery document comprises an Open Resource Discovery document comprising an API resource entry corresponding to the machine-callable data action definition.

9. The system of claim 1, further comprising an action matching service configured to compare a context field set of a consuming enterprise system with the required input parameter schema and to generate a matched data action list.

10. The system of claim 1, further comprising a metadata change detector configured to detect changed view metadata and to cause regeneration of at least one of the activation field group, the machine-callable data action definition, the action catalog, or the machine-readable discovery document.

11. A computer-implemented method for generating discoverable machine-callable data actions, the method comprising:
retrieving, by an enterprise view metadata parser, view metadata associated with an enterprise data store, the view metadata comprising a primary view field catalog of a primary enterprise data view and a related-resource key field set of a related enterprise resource;
comparing, by an activation field group resolver, the primary view field catalog with the related-resource key field set;
generating, by the activation field group resolver, an activation field group identifying one or more fields sufficient to query, retrieve, subscribe to, or consume data from the related enterprise resource;
generating, by an action-schema generator, a machine-callable data action definition comprising an action identifier and a required input parameter schema derived from the activation field group;
storing or publishing, by a publication interface, the machine-callable data action definition in at least one of an action catalog or a machine-readable discovery document;
receiving, by an action execution gateway, an action invocation request identifying the machine-callable data action definition; and
issuing a validated query, retrieval request, subscription request, or consumption request for the related enterprise resource only after validating that the action invocation request includes values corresponding to the required input parameter schema.

12. The method of claim 11, wherein the primary enterprise data view comprises a customer-defined custom view on a standard business object.

13. The method of claim 11, wherein the related enterprise resource comprises a replication object generated based on a customer-defined custom view.

14. The method of claim 11, wherein the related enterprise resource comprises a change-log stream or message-bus topic associated with create, update, delete, insert, modify, or destroy operations.

15. The method of claim 11, wherein storing or publishing the machine-callable data action definition comprises generating an Open Resource Discovery document comprising an API resource entry corresponding to the machine-callable data action definition.

16. The method of claim 11, further comprising comparing a context field set of a consuming enterprise system with the required input parameter schema and generating a matched data action list comprising one or more machine-callable data actions invocable from the context field set.

17. The method of claim 11, further comprising rejecting the action invocation request when at least one of the following occurs:
the action invocation request omits a value required by the activation field group;
the action invocation request fails validation against an access rule;
the action invocation request fails validation against a retention rule;
the action invocation request fails validation against a lifecycle rule; or
the action invocation request fails validation against a policy rule governing query, retrieval, subscription, event consumption, or message-bus consumption.

18. A non-transitory computer-readable storage medium storing instructions which, when executed by one or more processors, cause the one or more processors to perform operations comprising:
retrieving view metadata associated with an enterprise data store, the view metadata comprising a primary view field catalog of a primary enterprise data view and a related-resource key field set of a related enterprise resource;
generating an activation field group by comparing the primary view field catalog with the related-resource key field set, the activation field group identifying one or more fields sufficient to query, retrieve, subscribe to, or consume data from the related enterprise resource;
generating a machine-callable data action definition comprising an action identifier and a required input parameter schema derived from the activation field group;
storing or publishing the machine-callable data action definition in at least one of an action catalog or a machine-readable discovery document; and
causing an action execution gateway to issue a validated query, retrieval request, subscription request, or consumption request for the related enterprise resource only after validating that an action invocation request includes values corresponding to the required input parameter schema.

19. The non-transitory computer-readable storage medium of claim 18, wherein the enterprise data store comprises a tenant archive store, wherein the enterprise data comprises historized enterprise data, and wherein the primary enterprise data view comprises an archive view generated from metadata comprising custom fields, custom tables, or foreign-key relationships.

20. The non-transitory computer-readable storage medium of claim 18, wherein the operations further comprise supplying the machine-callable data action definition to an artificial-intelligence planner as part of a generated tool manifest, receiving a proposed agent action from the artificial-intelligence planner, and rejecting the proposed agent action when the proposed agent action does not include values corresponding to the activation field group.
